(19) United States
(12) Patent Application Publication
(10) Pub. No.: US 2014/0147631 A1
(43) Pub. Date: May 29, 2014

(54) MANUFACTURE OF HYDROPHOBIC SURFACES

(71) Applicant: The Trustees of The University of Pennsylvania, Philadelphia, PA (US)

(72) Inventors: Shu Yang, Blue Bell, PA (US); Raghuraman Govindan Kurunakaran, Tamil Nadu (IN); Lebo Xu, Henrico, VA (US)

(73) Assignee: The Trustees of The University of Pennsylvania, Philadelphia, PA (US)

(21) Appl. No.: 14/046,382

(22) Filed: Oct. 4, 2013

Related U.S. Application Data
(63) Continuation-in-part of application No. PCT/US2012/032511, filed on Apr. 6, 2012.
(60) Provisional application No. 61/472,407, filed on Apr. 6, 2011.
(60) Provisional application No. 61/472,841, filed on Apr. 7, 2011.

(51) Int. Cl. C09D 7/12; B05D 1/00

(52) U.S. Cl. CPC C09D 7/1233; B05D 1/00
USPC 428/143; 427/201

(57) ABSTRACT

Provided are methods of producing hydrophobic surfaces that in some embodiments include nanoparticle populations that differ in cross-sectional dimension and a coating of a low surface energy material. Also are provided are methods for producing such hydrophobic surfaces. Methods for producing transparent hydrophobic surfaces with functionalized nanoparticles and low surface energy polymers are also provided.

### RELATED APPLICATIONS

The present application is a continuation-in-part of presently-pending international application no. PCT/US2012/032511, “Design and Manufacture of Hydrophobic Surfaces,” filed on Apr. 6, 2012. That international application claims priority to U.S. application no. 61/472,407, “Manufacture of Hydrophobic Surfaces,” filed on Apr. 6, 2011, and also to U.S. application no. 61/472,841, “Hydrophobic Materials,” filed on Apr. 7, 2011. All of the foregoing applications are incorporated herein in their entireties for any and all purposes.

### STATEMENT OF GOVERNMENT RIGHTS

The present work was supported by grant no. NSF CAREER DMR-0548070, awarded by the National Science Foundation. The government has rights in the invention.

### TECHNICAL FIELD

The present disclosure relates to the field of hydrophobic and oleophobic materials. The disclosure also relates to the field of nanoparticles.

### BACKGROUND

Hydrophobic surfaces have many uses. Some surfaces are superhydrophobic in nature, and exhibit a contact angle of about 150° or higher, on which a water droplet rolls off easily. This may result in so-called self-cleaning behaviors. These hydrophobic surfaces play an important role in a wide range of applications ranging from biotechnology to water-repellent materials. A robust hydrophobic surface capable of self-cleaning is also of interest for use in exposed portions of photovoltaic cells, so as to allow maximum electromagnetic radiation reach the photovoltaic cell.

Transparency and surface roughness are generally competitive properties. When surface roughness increases, hydrophobicity increases, whereas the transparency often decreases because of Mie scattering from the rough surface. When the roughness dimension is much smaller than the light wavelength, the film becomes increasingly transparent due to refractive index change between air and substrate, which effectively reduces the intensity of refraction at the air (or water)/film interface and increases the optical quality. To achieve high transparency in the visible light, the size of surface roughness should be no larger than 100 nm. A few groups have attempted to create transparent superhydrophobic surfaces.

Multiple steps and complicated processes may, in some cases, be needed to impart hydrophobicity to a surface. Further, it remains a challenge for a surface to maintain the hydrophobicity over time. Accordingly, there is a need in the art for materials that maintain their superhydrophoboic surfaces over time and for methods of fabricating such materials. Furthermore, many superhydrophobic or highly hydrophobic surfaces are not transparent, therefore, limiting their applications.

### SUMMARY OF THE INVENTION

The present disclosure is directed to approaches to generate articles with sufficient roughness and to the articles themselves. The articles exhibit hydrophobic properties. The articles may also exhibit superhydrophobic properties. The articles may also exhibit optical transparency or near-transparency.

In one aspect, the present invention provides a hydrophobic article, comprising, a substrate at least partially surmounted by a first population of nanoparticles, the first population of nanoparticles contacting a second population of nanoparticles, the first and second populations of nanoparticles differing from one another in at least cross-sectional dimension, and a low surface energy material surmounting at least some of the first and second populations of nanoparticles such that the hydrophobic layer is exposed to the environment exterior to the article.

The present invention also provides a method of fabricating a transparent hydrophobic article, comprising, contacting a substrate with a first population of nanoparticles so as to bind at least a portion of the first population of nanoparticles to the substrate, at least one of the substrate and the first population of nanoparticles being configured to bind to the other, introducing a second population of nanoparticles so as to give rise to the second population of nanoparticles binding to the substrate, to the first population of nanoparticles, or both, so as to give rise to a particle-bearing article, and depositing a thin layer of hydrophobic material atop at least a portion of the particle-bearing article.

Further disclosed are hydrophobic articles, the articles including a substrate at least partially surmounted by a first population of hydrophobic nanoparticles, the first population of hydrophobic nanoparticles contacting a second population of hydrophobic nanoparticles, the first and second populations of hydrophobic nanoparticles differing from one another in at least cross-sectional dimension.

Additionally provided are methods of fabricating a hydrophobic article, the methods including contacting a substrate with a first population of hydrophobic nanoparticles so as to bind at least a portion of the first population of hydrophobic nanoparticles to the substrate, at least one of the substrate and the first population of hydrophobic nanoparticles being configured to bind to the other; introducing a second population of hydrophobic nanoparticles so as to give rise to the second population of hydrophobic nanoparticles binding to the substrate, to the first population of hydrophobic nanoparticles, or both, so as to give rise to a particle-bearing article.

Also disclosed are hydrophobic articles, the articles including a substrate at least partially surmounted by a coating that includes population of surface functionalized nanoparticles, with at least some of the nanoparticles comprising surface functionalities of fluorosilanes or alkaylsilanes.

Additionally provided are methods of fabricating a hydrophobic article, the methods including contacting a population of nanoparticles to a substrate, at least some of the nanoparticles comprising surface functionalities of fluorosilane or alkylsilane with at least a portion of the substrate comprising surface functionalities of fluorosilane or alkylsilane, the contacting giving rise to at least a portion of the substrate being surmounted by at least a portion of the nanoparticles.

Also disclosed are hydrophobic articles, the articles including a substrate and a coating surmounting the substrate, the coating comprising surface functionalized nanoparticles and a low surface energy polymer.

Additionally provided are methods of fabricating a hydrophobic article, the methods including dispersing a population of surface functionalized hydrophobic nanoparticles and a low energy polymer to give rise to an admixture and depositing the admixture onto a substrate.

Moreover, methods are provided for fabricating a hydrophobic article, the methods including oxidizing a silicon wafer, silanating the oxidized silicon wafer, flurosilanating the silanated silicon wafer, and then introducing a population of surface functionalized nanoparticles.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates a schematic illustration of fabrication of hydrophobic/oleophobic surfaces with dual scale roughness;

FIG. 2 illustrates water contact angle image of the nanoparticle (NP) treated silicon wafer, which was dip coated with 20 nm aminopropryltrimethoxysilane (APTS) coated silica nanoparticles (0.5 wt % in ethanol), followed by dip coating 100 nm APTS coated silica nanoparticles (0.8 wt %), followed by vapor deposition of (heptadecafluoro-1,1,2,2,-tetrahydrodecyl)trichlorosilane (fluorosilane) for 6 h;

FIG. 3. SEM images of monoscaled APTS-SiO₂ nanoparticles dip coated on Si wafers. (a-c) 20 nm nanoparticles. (a) 0.1 wt %, (b) 0.5 wt %, and (c) 1.0 wt %. (d-f) 50 nm nanoparticles. (d) 0.1 wt %, (e) 0.5 wt %, and (f) 1.0 wt %. (g-i) 100 nm nanoparticles. (g) 0.1 wt %, (h) 0.5 wt %, and (i) 1.0 wt %. Scale bar, 500 nm, is applicable to all images.

FIG. 4. SEM images of dual-sized APTS-SiO₂ nanoparticles successively dip coated on Si wafers with 100 nm and 20 nm nanoparticles at different concentrations. (a) 100 nm nanoparticles (0.5 wt %) and 20 nm nanoparticles (0.5 wt %). (b-d) 100 nm nanoparticles deposited first at different concentrations: (b) 0.5 wt %, (c) 0.8 wt % and (d) 1.0 wt %, followed by deposition of 20 nm nanoparticles (0.5 wt %) and fluorosilane treatment for 30 min. Scale bars: 200 nm. Insets: optical image of 5 μL water droplet on nanoparticle films.

FIG. 5. SEM images of dual-sized APTS-SiO₂ nanoparticles successively dip coated on Si wafers with 20 nm and 100 nm nanoparticles at different concentrations. (a-b) Deposition of 20 nm SiO₂ nanoparticles (0.5 wt %) followed by 100 nm SiO₂ nanoparticles (0.5 wt %) without (a) and with fluorosilane treatment for 1 h (b). (c-d) Deposition of 20 nm SiO₂ nanoparticles (0.5 wt %) followed by 100 nm SiO₂ nanoparticles (0.8 wt %) without (c) and with fluorosilane treatment for 1 h (d). Scale bars: 500 nm.

Table 1: Water contact angles of 20 nm APTS modified silica nanoparticle films deposited on Si wafers, followed by fluorosilane treatment for different durations.

Table 2: Water contact angles of 50 nm APTS modified silica nanoparticle films deposited on Si wafers, followed by fluorosilane treatment for different durations

Table 3: Water contact angles of 100 nm APTS modified silica nanoparticle films deposited on Si wafers, followed by fluorosilane treatment for different durations

Table 4: Summary of Static and Dynamic Water Contact Angles measured on nanoparticle films coated on different polymeric substrates;

FIG. 6: Optical transparency of the dual-sized nanoparticle film. (a) Optical photograph of water droplets (7 μL) on glass coated with 100 nm SiO₂ nanoparticles (0.5 wt %), followed by deposition of 20 nm SiO₂ nanoparticles (0.5 wt %) and fluorosilane treatment for 3 h. (b) UV-vis spectra of superhydrophobic nanoparticle films dip coated in different sequences and compared to bare glass;

FIG. 7: Optical photographs of (a) 5 μL water droplets (mixed with malachite green dyes) and (b) 10 μL paraffin oil droplets on polyester fabrics with (left) and without (right) dual sized nanoparticles to illustrate superhydrophobicity and oleophobicity;

Table 5: Water contact angles of 100 nm APTS modified silica nanoparticle films deposited on Si wafers, followed by fluorosilane treatment for different durations.

FIG. 8 illustrates snap-shot images of water droplets beading off an exemplary superhydrophobic surface (tilting angle less than 5 degrees as seen from the scale), which was dip coated with 100 nm APTS functionalized silica nanoparticles (0.8 wt % in ethanol), followed by dip coating of 20 nm APTS functionalized silica nanoparticles (0.5 wt %) and vapor deposition of (heptadecafluoro-1,1,2,2,-tetrahydrodecyl)trichlorosilane (fluorosilane) for 3 h.

Table 6: Water contact angles of Si wafers coated with single sized APTS-SiO₂ nanoparticles with variable nanoparticle concentrations and fluorosilane treatment time;

Table 7: Water contact angles of Si wafers coated with two different sized APTS-SiO₂ nanoparticles (100 nm first and 20 nm second) with variable nanoparticle concentrations and fluorosilane treatment time. After depositing the first layer of nanoparticles, the substrate was annealed at 400° C. for 2 h.;

Table 8: Water contact angles of Si wafers coated with two different sized APTS-SiO₂ nanoparticles (20 nm first and 100 nm second) with variable nanoparticle concentrations and fluorosilane treatment time. After depositing the first layer of nanoparticles, the substrate was annealed at 400° C. for 2 h;

Table 9: Effect of annealing treatment (400° C. for 2 h) after the deposition of first layer of SiO₂ NPs on water contact angle and RMS roughness. The RMS roughness was obtained from AFM

Table 10: Summary of water contact angles on surfaces with dual-scale roughness: Si wafers dip coated with 20 nm SiO2 nanoparticles without annealing, followed by spin coating of 100 nm SiO2 nanoparticles and fluorosilane deposition;

Table 11: Summary of water contact angles on surfaces with dual-scale roughness: Si wafers dip coated with 100 nm SiO2 nanoparticles without annealing, followed by spin coating of 20 nm SiO2 NPs and fluorosilane deposition;

Table 12: Summary of water contact angles on surfaces with dual-scale roughness: Si wafers dip coated with 20 nm SiO2 nanoparticles annealed at 400° C. for 2 h, followed by dip coating of 50 nm SiO2 nanoparticles and fluorosilane deposition;

Table 13: Summary of water contact angles on surfaces with dual-scale roughness: Si wafers dip coated with 50 nm SiO2 nanoparticles annealed at 400° C. for 2 h, followed by dip coating of 20 nm SiO2 nanoparticles and fluorosilane deposition;

Table 14: Summary of water contact angles on surfaces with dual-scale roughness: Si wafers dip coated with 50 nm SiO2 nanoparticles annealed at 400° C. for 2 h, followed by dip coating of 100 nm SiO2 nanoparticles and fluorosilane;

Table 15: Summary of water contact angles on surfaces with dual-scale roughness: Si wafers dip coated with 100 nm SiO2 nanoparticles annealed at 400° C. for 2 h, followed by dip coating of 50 nm SiO2 nanoparticles and fluorosilane deposition;

Table 16: Summary of water contact angles on surfaces with dual-scale roughness: Si wafers dip coated with 100 nm SiO2 nanoparticles annealed at 400° C. for 2 h, followed by dip coating of 20 nm SiO2 nanoparticles and n-octadecyltrichlorosilane (OTS) deposition in toluene;

Table 17: Summary of water contact angles on Si wafers of dual-scale roughness but without succinic anhydride silane treatment nor thermal annealing;

Table 18: Summary of water contact angles on surfaces with dual-scale roughness: glass substrates dip coated with 20 nm SiO2 nanoparticles and annealed at 400° C. for 2 hrs, followed by dip coating 100 nm SiO2 nanoparticles and fluorosilane deposition;

Table 19: Summary of water contact angles on surfaces with dual-scale roughness: glass substrates dip coated with 100 nm SiO2 nanoparticles and annealed at 400° C. for 2 hr, followed by dip coating 20 nm SiO2 NPs and fluorosilane deposition;

Table 20: Summary of water contact angles on surfaces with dual-scale roughness: PDMS films were subjected to oxygen plasma treatment at 30 W for 45 seconds and then dip-coated with 20 nm SiO2 nanoparticles, followed by dip-coating of 100 nm SiO₂ nanoparticles (vice versa) and fluorosilane deposition;

Table 21: Summary of water contact angles on surfaces with dual-scale roughness: SU-8 films were subjected to oxygen plasma treatment at 30 W for 45 seconds and then dip-coated with 20 nm SiO₂ nanoparticles, followed by dip-coating of 100 nm SiO₂ nanoparticles (vice versa) and fluorosilane deposition;

Table 22: Comparison of water contact angles on plain Si wafers (or glass) with and without succinic anhydride silane treatment;

Table 23: Summary of water contact angle from surfaces with multi-scale roughness: Si wafer dip-coated with 20 nm, 50 nm, 100 nm (or 100 nm, 50 nm, 20 nm) SiO2 nanoparticles sequentially, followed by annealing at 400° C. for 2 h and fluorosilane deposition;

Table 24: Summary of water contact angle from Si surfaces with multi-scale roughness: Si wafer dip-coated with 20 nm, 50 nm, 100 nm (or 100 nm, 50 nm, 20 nm) SiO2 nanoparticles sequentially, followed by vapor deposition of fluorosilane without thermal annealing;

Table 25: Water contact angles of spin-coated and dip-coated 100 nm F—SiO₂ nanoparticles on different substrates at various nanoparticle concentrations;

Table 26 Measured static water contact angle (Oₛₜ), roughness factor(r), number density of nanoparticles (N), and the theoretical Wenzel contact angle (θ^{w}), filling fraction (f), and estimated azimuthal angle (φ).

Table 27 DI water contact angles of 0.8 wt % F—SiO₂ NPs spin coated on glass before and after the water drop test and the Scotch tape test.

Table 28: Water contact angles of fluorofunctionalized SiO₂ nanoparticles spin-coated on PS and PMMA films;

FIG. 9 illustrates the synthesis of fluorosilane funcitionalized silica (F—SiO₂) nanoparticles with (heptadecafluoro-1,1,2,2,-tetrahydrodecyl) dimethylchlorosilane (HDFTHD).

FIG. 10 illustrates scanning electron microscopy (SEM) images of spin-coated 100 nm F—SiO₂ nanoparticles with different concentrations on 3-(triethoxysilyl)-propyl succinic anhydride (TESPSA)-functionalized Si wafers: (a) 0.1, (b) 0.4, (c) 0.8, and (d) 1.2 wt %. The insets in c and d are high-magnification images. Scale bars: 1 μm;

FIG. 11 depicts atomic force microscopy (AFM) images of 100 nm F—SiO₂ nanoparticles spin-coated on TESPSA treated Si wafers from Novec 7300 treated solutions at different nanoparticle concentrations (a) 0.1, (b) 0.4, (c) 0.8, and (d) 1.2 wt. %;

FIG. 12 is a schematic illustration of Cassie-Baxter nonwetting behavior on close-packed hydrophobic particles;

FIG. 13 is a SEM image of F—SiO₂ nanoparticles (0.8 wt. % in decafluoropentane) dip-coated on TESPSA treated Si. Scale bar: 500 nm;

FIG. 14 depicts the optical transparency of spin-coated F—SiO₂ nanoparticle film (1.0 wt. %) on a glass substrate. (a) Photograph of water droplets on F—SiO₂ nanoparticle coated glass substrate. (b) UV-vis spectrum of the galss substrates with and without F—SiO₂ nanoparticle coating; a small amount of dimethyl methylene blue dye was dissolved in water for illustration purpose;

FIG. 15 is AFM images of 0.8 wt. % F—SiO₂ NPs coated on glass before (a) and after the water test (b) and the Scotch tape test (c). All images are of 5 μm×5 μm scale with the height scale bar of 200 nm;

FIG. 16 is an optical photograph of water droplets (>10 μL) on F—SiO₂ nanoparticles coated polyester fabric; a small amount of dimethyl methylene blue dye was dissolved in water for illustration purpose;

Table 29: Tested coating formula with varying particle and polymer concentrations and measured water contact angle, roughness index (r) and theoretical Wenzel contact angle (θ^{w});

FIG. 17 depicts AFM phase image of sample 1 (from Table 30), Pure CYTOP™, which is flat and homogeneous;

FIG. 18 is an AFM phase image of sample 2 (from Table 30). Majority of F—SiO₂ NPs are buried in CYTOP™ layer when particle concentration is low, 1 mg/mL·wt % particle/CYTOP™. A few particles are merely exposed on top as shown. The covered particles can be distinguished from the exposed particles based on surface feature. The thickness of CYTOP™ layer is estimated ˜100 nm considering the particle size of 100 nm;

FIG. 19 is an AFM phase image of sample 3 (from Table 30). More particles are exposed when particle concentration is increased to 10 mg/mL·wt % particle/CYTOP™;

FIG. 20 is an AFM phase image of sample 4 (from Table 30). Even more particles are exposed when particle concentration is increased to 28 mg/mL·wt % particle/CYTOP™;

FIG. 21 is an AFM phase image of sample 5 (from Table 30). Particle concentration is increased to 100 mg/mL·wt % particle/CYTOP™;

FIG. 22 is an AFM phase image of sample 6 (from Table 30). At the highest particle concentration tested, 200 mg/mL·wt % particle/CYTOP™, all particles are exposed. No polymer phase is observed;

FIG. 23 is a comparison of the measured water CA vs. theoretical values as a function of the ratio between particles and polymers of sample 5, Table 30;

FIG. 24 is an UV-vis spectra of glass spin coated with polymer (1 wt %) and polymer (0.1 wt %)/particle (10 mg/mL) mixture of sample 5, Table 30;

FIG. 25 is the water contact angle on samples before and after Scotch tape test of sample 5, from Table 30;

FIG. 26 is an AFM phase image of sample 1 (Table 30) after tape test. The pure CYTOP™ coating is flat and homogeneous. The result indicates CYTOP™ can stick on untreated substrate;

FIG. 27 is an AFM phase image of sample 2 (Table 30) after tape test. No change is observed compared to FIG. 17 after tape test;

FIG. 28 is an AFM phase image of sample 3 (Table 30) after tape test. No change is observed compared to FIG. 18 after tape test;

FIG. 29 is an AFM phase image of sample 4 (Table 30) after tape test. No particle was removed after tape test;

FIG. 30 is an AFM phase image of sample 5 (Table 30) after tape test. No particle was removed after tape test;

FIG. 31 is an AFM phase image of sample 6 (Table 30) after tape test. Particles were removed after tape test when the ratio between particle concentration and polymer concentration exceed a threshold value;

FIG. 32 is a section analysis on AFM height image of sample 6 (Table 30) after tape test;

Table 30: Water contact angles on various polycarbonate (PC) substrates;

FIG. 33: AFM phase images of polymer/particle coating on a PC substrate (a) and a glass substrate (b) after the Scotch tape test. The assembly remains intact on both substrates;

FIG. 34 illustrates a schematic of experimental set up to test the corrosion resistance of a spray-coated PCB board operated in a saturated salt water environment;

FIG. 35 illustrates an anti-corrosion coating on a PCB board for the 8 mg/mL GR653L/F-NP formulation. A) AFM of the scratched surface. B) Height profile of scratch as scanned by AFM. C) Current vs. time measurement for typical coating;

FIG. 36 illustrates an anti-corrosion coating on a PCB board from the 12 mg/mL GR653L/F-NP formulation. A) AFM image of a scratched surface. B) AFM height profile of the scratched surface. C) Current vs. time measurement for a typical coating;

FIG. 37 illustrates an anti-corrosion coating on a PCB board from the Cytop/F-NP formulation. A) AFM image of a scratched surface. B) AFM height profile of the scratched surface. C) Current vs. time measurement for a typical coating;

FIG. 38 illustrates (top)-Nylon Mesh and (bottom)-Cotton spray coated with superhydrophobic coating.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. Any documents cited herein are incorporated by reference in their entireties for any and all purposes.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

A superhydrophobic surface is one that exhibits a contact angle of 150° or higher, on which a water droplet rolls off easily, resulting in so-called self-cleaning behaviors. Generally, wetting behavior is dependent on both surface chemistry (i.e. surface energy) and surface topography (i.e. physical roughness). The surface topography can significantly enhance the hydrophobicity or hydrophilicity.

Provided herein are hydrophobic articles. These articles suitably include a substrate at least partially surmounted by a first population of nanoparticles with the first population of nanoparticles contacting a second population of nanoparticles. The first and second populations of nanoparticles suitably differ from one another in at least cross-sectional dimension, but may also differ from one another in terms of material composition as well. The articles also suitably include a low surface energy material surmounting at least some of the first and second populations of nanoparticles such that the hydrophobic layer is exposed to the environment exterior to the article. The disclosed articles and methods are especially suitable for use in photovoltaic cells, as the articles' hydrophobicity discourages water accumulation or other materials (e.g., bird droppings) on the surface of the cell.

Furthermore, in another embodiment, the nanoparticles are functionalized prior to being deposited on a substrate. Additionally, a low surface energy polymer may also be introduced. Some suitable such polymers are described elsewhere herein.

Silica nanoparticles offer benefits of simplicity, low cost, tunable size, and excellent scratch resistance. However, they may be hydrophilic and negatively charged. To make a surface superhydrophobic using silica nanoparticles, a thin layer of low-surface-energy coating is necessary to be deposited on the newly generated rough surface, which is usually achieved by vapor deposition under vacuum or by solution casting. One may manipulate the hydrophobic nanoparticle coverage on the surface to minimize the exposure of the underlying substrate, which substrate may not be hydrophobic. Nanoparticles according to the present disclosure may be neutral or non-neutral in charge.

The substrate may comprise a variety of materials. Exemplary materials include silicon, glass, poly(dimethylsiloxane), polyester, poly(styrene), poly(methyl methacrylate), poly(carbonate), and the like. Other plastics, films, and fabrics are also suitable, as the present disclosure is not limited to any particular substrate material. Glass, silicon, and polymers (e.g., polyamide, polyimide, polyester) are all considered suitable substrates. As further examples, the disclosed coatings and materials may be used in a variety of applications, some of which include roofing, concrete/construction, wood preservation, anti-mold applications in buildings, marine environment equipment, wires, cables, pipes, automotive (exterior and electronics), outdoor signage, solar panels, and the like.

Before nanoparticle deposition, a substrate may be treated to facilitate the binding or adhering of the nanoparticles to the substrate. Suitable compounds that give rise to such binding sites on the substrate are triethoxysilylpropylsuccinic anhydride, trimethoxysilylproprylsuccinic anhydride, aminopropyltriethoxysilane, aminopropyltrimethoxysilane, 3-glycidopropyltriethoxysilane, 3-glycidopropyltrimethoxysilane, aminobutyldimethylmethoxysilane or similar type of compound.

Different types of nanoparticles may be used according to the present disclosure. Some such nanoparticles include (but are not limited to) silica, titania, polystyrene, or poly(methyl methacrylate). The nanoparticles may either be charged positively or negatively. The nanoparticles may be functionalized to give rise to either hydrophobic nanoparticles or hydrophilic nanoparticles. The nanoparticle exterior may contain an amine, carboxylic acid, or hydroxyl functionalities to produce a hydrophilic nanoparticle. One embodiment features treating a nanoparticle with 3-aminopropyltrimethoxysilane. However, virtually any chemical moiety which allows for the exterior of the nanoparticle to be charged is suitable for this invention. While it is not necessary for the nanoparticles to be charged, it facilitates prevention of nanoparticle aggregation and provides for facilitating a uniform, monolayer of nanoparticles on the substrate. The nanoparticles may also be treated with a fluorinated silane or alkyl silane as to give rise to a hydrophobic nanoparticle. For example, treating a hydrophilic nanoparticle with dimethylchlorosilane with hydrophobic end groups, such as heptadecafluoro-1,1,2,2-tetrahydrodrodecyl) dimethylchlorosilane, tridecafluoro-1,1,2,2-tetrahydroctyldimethylchlorosilane, Tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, and n-octadecyldimethylchlorosilane, dodecyldimethylchlorosilane or any combination thereof will give rise to a hydrophobic nanoparticle.

The nanoparticle populations deposited onto the substrate suitably differ in their cross-sectional dimension, e.g., their diameter. The average diameter for a given population may be in the range of from about 1 nm up to about 200 nm, or from about 10 nm to about 100 nm, or even from about 20 nm to about 50 nm. Nanoparticles having a diameter of between about 10 nm and 110 nm are considered particularly suitable for a transparent surface, although these nanoparticle dimensions are not necessary

In a given nanoparticle population, the population's variance in diameter from the mean diameter of the population may be 50%, 20%, 15%, 10%, 5%, 1% or even less. For example, a population of nanoparticles may have a mean diameter of about 50 nm, with the particles within the population being between 40 nm and 60 nm in diameter. Monodisperse populations of nanoparticles are particularly suitable, but are not necessary; as described elsewhere herein, polydisperse nanoparticle populations may also be used.

The size ratio between the diameters of two populations may be between 0.0001 to about less than 1. More preferably, the ratio is in the range of about 0.2 or less. For example, a first population of nanoparticles may have a diameter of about 20 nm, and the second population of nanoparticles may have a diameter of about 100 nm, giving rise to a ratio of about 0.2.

In other embodiments, the size ratio may approach a value of about 1, so that there is effectively only one population when the nanoparticles are functionalized prior to deposition. Accordingly, it should be understood that although some embodiments of the disclosed technology include nanoparticles that differ from one another in terms of size, composition, or both, other embodiments include nanoparticles that share size, composition, or both, e.g., in a unimodal population. It will be understood by one of ordinary skill in the art what size ratios are suitable for the different embodiments presented herein.

In some embodiments, the larger nanoparticles are deposited first, followed by deposition of the smaller nanoparticles. Conversely, the smaller nanoparticles may be deposited first, followed by the deposition of the larger nanoparticles.

While certain illustrative embodiments describe dual-roughness articles that include two populations of nanoparticles, a user may also form articles that include three, four, or even more populations of nanoparticles so as to give rise to an article having a multi-roughness surface. A user may even apply a population of nanoparticles that is polydisperse or even essentially random with respect to nanoparticles diameter may be used. For example, a user may apply a nanoparticle population that contains nanoparticles having 2, 3, 4, 5, 10, 25, 50, 100, or even more different cross-sectional dimensions. In another embodiment, a polydisperse nanoparticle population may be used.

Nanoparticles may be deposited via a variety of techniques, including dip-coating. The nanoparticles may be in a solution with a solvent or mixture of solvents that have a boiling point of about 60 to 80° C. for dip-coat methods. The solvent may be methanol, ethanol, acetone, toluene, tetrahydrofuran, or similar solvents and mixtures thereof. The solution may have a concentration of 0.1 wt. % to 1.5 wt. % of nanoparticles. More preferably, the concentration of nanoparticles should be between 0.5 wt. % to 1.2 wt. %. The substrate is suitably contacted with the nanoparticle solution for time sufficient that the nanoparticles are adsorbed, either chemically or physically, onto the substrate with sufficient stability.

Adsorption of the nanoparticles onto the substrate will reach an equilibrium state if given sufficient time. The contacting time is typically between about 3-10 seconds, or even about 5 seconds. The modified substrate may be removed from the nanoparticle solution at a rate of about 1-5 cm/min, e.g., about 4 cm/min. The coating and removal are suitably performed to as to allow the nanoparticles to achieve an equilibrium with the surface so as to achieve uniform coating, where possible. The user of skill in the art will encounter little difficulty in determining the optimal process parameters for a given application.

Nanoparticles may also be deposited by the spray-coating method. The nanoparticles should be in a solution with a solvent or mixture of solvents that have a boiling point of about 60 to 80° C. for the spray-coat method. The solvent may be methanol, ethanol, acetone, toluene, tetrahydrofuran, or similar solvents or any mixture thereof.

The nanoparticles may also be deposited by the spin-coating method. The nanoparticles should be in a solution or mixture of solvents having a boiling point of above 100° C. for the spin-coat method. The solution or mixture of solvents may have a boiling point as high as about 200° C. More specifically, solvents may include gamma-butyrolactone, methyl ethyl ketone, propylene glycol methyl ether acetate, n-butanol or similar solvents or a mixture thereof. The solution may have a concentration of 0.1 wt. % to 1.5 wt. % of nanoparticles. More preferably, the concentration of nanoparticles should be between 0.5 wt. % to 1.2 wt. %.

Thermal annealing may be used to enhance the adhesion and stability of the nanoparticle populations on the substrate. The annealing may be performed after the first deposition of a population of nanoparticles, after the second deposition of a population of nanoparticles, or after both. The thermal annealing may be performed between 25°-450° C. for about 0.5-3 hours. In one embodiment, the thermal annealing is performed at about 400° C. for about 2 hours. UV curing processes may also be used, as well as dehydration curing processes, such as those that use an acid catalyst. Radical-based (e.g., ambient oxygen) curing techniques can be used as well.

The introduction of hydroxyl groups and the stability of the nanoparticle population on the substrate can be further enhanced by a treatment, such as an oxygen plasma treatment. An exemplary oxygen plasma treatment is performed at about 20 Watts to about 100 Watts for about 0.1 min to about 2 min. The oxygen plasma treatment can be performed at 30 Watts for about 1 min.

The surface of the nanoparticles may be coated with a material that has a low surface energy. The low surface energy material may be a silane that contains a hydrophobic end group. Suitable materials having sufficient low surface energy include (heptadecafuloro-1,1,2,2-tetrahydrodecyl(trichlorosiloxane), heptadecafuloro-1,1,2,2-tetrahydrodecyl (dimethylchlorosiloxane), fluoroalkyl monosilane, perfluoroether di-silane, perfluoroether poly-silane, n-octadecyltrichlorosilane (OTS), dimethyloctadecylchlorosilane, decyltrichlorosilane, or any combination thereof. The foregoing list is exemplary only, and one skilled in the art will encounter little difficulty in identifying other suitable compounds.

Nanoparticle surfaces may be coated by, e.g., vapor deposition, reflux the nanoparticle coated substrate in the silane solution, or spin coating a diluted silane solution. The thickness of the low surface energy material may vary depending on the method employed. For example, if no moisture or temperature control is employed, the thickness can be about 5 to 10 nm due to formation of a multilayer silane. A monolayer may have a thickness of about 2 to about 3 nm. The overall coating thickness may be in the range of the thickness of a single nanoparticle and greater, depending on the materials used in the coating and also depending on the number of layers in the coating. A coating may define an overall thickness in the range of, e.g., 10 nm to about 10 micrometers, or from about 50 nm to about 10 micrometer, or even from about 100 nm to about 1 micrometer. A user may modulate coating thickness depending on the user's own needs; in some embodiments, a user may desire a comparatively thin coating so as to reduce the weight of the coated article. A user may also modulate coating thickness based on the desired transparency or translucency of the finally coated article.

Additionally, low surface energy polymers may be mixed with functionalized nanoparticles prior to deposition. Such suitable polymers include fluoropolymers, CYTOP™, Teflon™, semifluorinated polymers or perfluoropolyether or the like.

It is not necessary, however, that articles include nanoparticles atop a substrate, with the assembly then being covered by a hydrophobic layer or other low-energy material. In some embodiments, the articles suitably include a substrate at least partially surmounted by a first population of hydrophobic nanoparticles, with the first population of hydrophobic nanoparticles contacting a second population of hydrophobic nanoparticles. Thus, the nanoparticles themselves may be inherently hydro- or even oleophobic. The substrate may also itself be inherently hydrophobic, or may be coated with a hydrophobic (or other low-energy) material.

Suitable substrates and nanoparticle materials are described elsewhere herein. Plastics, glass, and the like are all considered suitable substrates.

The first and second populations of hydrophobic nanoparticles may differ from one another in at least cross-sectional dimension, but may also differ from one another in material composition. In some embodiments, the substrate is surmounted by two, three, five, or more nanoparticle populations. In some embodiments, the substrate may be characterized as being surmounted by a polydisperse population of nanoparticles.

Also disclosed are methods of fabricating hydrophobic articles. The methods include contacting a substrate with a first population of hydrophobic nanoparticles so as to bind at least a portion of the first population of hydrophobic nanoparticles to the substrate, with at least one of the substrate and the first population of hydrophobic nanoparticles being configured to bind to the other. The user may introduce a second population of hydrophobic nanoparticles so as to give rise to the second population of hydrophobic nanoparticles binding to the substrate, to the first population of hydrophobic nanoparticles, or both, so as to give rise to a particle-bearing article.

Further provided are hydrophobic articles. The articles suitably include a substrate that at least partially surmounted by a polydisperse population of nanoparticles to as to form a particle-bearing article. The population suitably includes nanoparticles that differ from one another in cross-sectional dimension by at least about 1 nm, and the particle-bearing article being at least partially surmounted by a low-surface energy material. Suitable such materials are described elsewhere herein.

The population of nanoparticles may include nanoparticles that differ from one another in cross-sectional dimension by at least about 10 nm. The population may also include includes nanoparticles that differ from one another in cross-sectional dimension by from about 1 nm to about 120 nm. For example, a substrate may be surmounted by a population of nanoparticles within which 40% of the nanoparticles have a diameter in the range of from 8-10 nm, 40% of the nanoparticles have a diameter in the range of from 108-112 nm, and the remainder of the nanoparticles have diameters that are randomly distributed between 10 nm about 110 nm. Alternatively, ⅓ of the nanoparticles atop the substrate may have a diameter in the range of from about 5 to about 10 nm, ⅓ of the nanoparticles may have a diameter in the range of from 30 nm to 35 nm, and ⅓ of the nanoparticles may have a diameter in the range of from about 105 nm to about 110 nm. Virtually any distribution of nanoparticle sizes may be used to provide a surface with multi-scale roughness.

Also provided herein are further hydrophobic articles. These articles suitable include a substrate that is at least partially surmounted by a coating that includes population of surface functionalized nanoparticles with at least some of the nanoparticles comprising surface functionalities of fluorosilanates. Suitable substrates include silicon wafers, glasses, polymer substrates, such as polystyrene, poly(methylmethacrylate), polyester, SU-8, and polycarbonate, papers (cellulose), metals. Virtually any material may serve as a substrate, and users of ordinary skill in the art will encounter little difficulty in identifying suitable substrate materials.

At least a portion of the surface of the nanoparticles may be functionalized with chlorosilane with hydrophobic end groups. Such materials include, e.g, (heptadecafluoro-1,1,2,2-tetrahydrodrodecyl) dimethylchlorosilane, tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, and n-octadecyldimethylchlorosilane, dodecyldimethylchlorosilane or any combination thereof. The user may manipulate the amount of surface area of the nanoparticles that is functionalized; it may be useful to functionalize 50, 75, 90, or even about 100% of the nanoparticle surface area. Such factors will depend on nanoparticle size, composition and functionalizing agent.

In some embodiments, passivation of the surface may be necessary to increase the adhesion of the nanoparticles to the substrate. For instance, a silicon wafer may first be oxidized and then silanted. Such suitable methods of oxidation include oxygen plasma, ozonlysis, Piranha solution (H₂SO₄: H₂O₂=3:1 (v/v)), and the like. Chemical oxidizing agents (e.g., H₂O₂, fluorine, chlorine, halogens, nitric acid, sulfuric acid, persulfuric acids, chlorite, chlorate, perchlorate, hypochlorite, chromium compounds, permanganate compounds, sodium perborate, N₂O, Ag₂O, osmium tetraoxide, Tollens' reagent, 2,2′ dipyridyldisulfide, and the like) may also be used, as those of Ordinary skill will appreciate other known oxidizing agents in the art. Suitable silanting agents include, but are not limited to, 3-(triethoxysilyl)-propyl succinic anhydride, 3-(trimethoxysilyl)-propyl succinic anhydridetriethoxylsilyproprylsuccic anhydride, trimethoxysilylproprylsuccinic anhydride, aminopropyltriethoxysilane, aminopropyltrimethoxysilane, 3-glycidopropyltriethoxysilane, 3-glycidopropyltrimethoxysilane, aminobutyldimethylmethoxysilane, and the like.

In other embodiments, passivation of the surface may also be accomplished with silanating with (heptadecafluoro-1,1,2,2-tetrahydrodecyl)trichlorosilane, dimethylchlorosilane with hydrophobic end groups, such as (heptadecafluoro-1,1,2,2-tetrahydrodrodecyl) dimethylchlorosilane tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, n-octadecyldimethylchlorosilane, dodecyldimethylchlorosilane or any combination thereof.

The functionalized nanoparticles maybe contacted with the substrate by a variety of methods including, but not limited to, spin coating, dip coating or spray coating. In preferred embodiments, the functionalized nanoparticles are spin coated. In some especially suitable embodiments, the nanoparticles may be tightly packed with little substrate surface area being exposed. By “tightly packed” is meant that less than about 30% fraction of the substrate surface is exposed to air.

The adhesion of the functionalized nanoparticles may be improved, without loss to hydrophobicity, with an addition of a low surface energy polymer. Suitable low surface energy polymers include, but not limited to, CYTOP™, Teflon™, semifluorinated polymers, perfluoropolyethers, other fluoropolymers, and the like.

The low surface energy polymer may be introduced by a variety of means. In one embodiment, a solution of functionalized nanoparticles is prepared in a solvent. In a separate solution, the low surface energy polymer is dissolved in the same type of solvent. Alternatively, the solvent may be different. The solution of functionalized nanoparticles and the solution of the low surface energy polymer are combined to form the admixture. In an alternative embodiment, the functionalized nanoparticles and the low surface energy polymer are dissolved in the same solution to form the admixture. Suitable solvents include, but are not limited to 1,1,1,2,2,3,4,5,5,5,-decafluoro-3-methoxy-4-(trifluoromethyl)-pentane and 3-ethoxy-1,1,1,2,3,4,4,5,5,6,6,6-dodecafluoro-2-trifluoromethyl-hexane. A person of ordinary skill in the art will recognize suitable solvents. Suitable concentrations of the functionalized nanoparticle solution range from about 0.1 mg/mL to 100 mg/mL. More preferred, the concentration will be from about 5 mg/mL to about 15 mg/mL.

The admixture (formed by any methods) is then contacted to the substrate. Suitable methods include spin coating, dip coating, or spray coating. A wide variety of substrates, such as silicon wafers, glasses, polymer substrates, such as polystyrene, poly(methylmethacrylate), polyester, SU-8, and polycarbonate, papers (cellulose), or metals may be employed. Chemical groups on the substrate and polymer may be used to effect bonding between the polymer and substrate.

The deposited functionalized nanoparticles and low surface energy polymer admixture should sufficiently cover the surface area of the substrate to achieve suitable properties. The ratio of functionalized nanoparticles to low surface energy polymer may be such that the low surface energy polymer binds the functionalized nanoparticles to the substrate, while there sufficient surface area of the functionalized nanoparticles is exposed.

### TERMS

“NPs” or “NP” as the terms are used herein, is defined as nanoparticles or nanoparticle.

“low surface energy material” as the term is used herein, is defined as a material having a surface energy lower than about 30 mN/m.

“contact angle” as the term is used herein, is defined as a the angle in which the liquid interface meets the substrate nanoparticle surface.

“roll-off angle” as the term is used herein, is defined as the angle in which a water droplet begins to roll off a gradually inclined surface.

“wetting behavior” as the term is used herein, is defined as the ability of a liquid to maintain contact with a the substrate nanoparticle surface.

“APTS” as the term is used herein, is defined as 3-aminopropyl trimethoxysilane.

“superhydrophobic surface” as the term is used herein, is defined as a surface with which the contact angle of a water droplet exceeds 150° and the roll-off angle is less than 10°.

“superhydrophlic surface” as the term is used herein, is defined as a surface with which water almost completely spreads on the surface.

“TESPA” as the term is used herein, is defined as 3-(triethoxysilyl)-proply succinic anhydride.

“F-silane” as the term is used herein, is defined as (heptadecafluoro-1,1,2,2-tetrahydrodecyl)trichlorosilane.

“HDFTHD” as the term is used herein, is define as (heptadecafluoro-1,1,2,2-tetrahydrodrodecyl) dimethylchlorosilane.

“OTS” as the term is used herein is n-octadecyltrichlorosilane

“low surface energy polymer” as there term is used herein, is defined as a surface energy of less than approximately 30 mJ/m².

### Exemplary Embodiments

Certain features were observed in exemplary embodiments. These features are described below.

Articles prepared according to the present disclosure exhibit a number of useful characteristics. First, the obtained hydrophobicity was robust against prolonged exposure to UV light at ambient conditions. The film remained hydrophobic when left on the lab bench for a month or under continuous UV exposure (200 mW/cm²) for a week.

Further, hydrophobic films obtained from co-assembly of dual-sized nanoparticles with diameters of 100 nm exhibited high optical transparency. The UV-vis spectra showed the hydrophobic film maintained the optical transparency (relative transmission>99%) in the visible wavelength with respect to bare glass.

Static and dynamic water contact angles were measured by Ramé-Hart standard automated goniometer Model 290. The static contact angle was measured from a 2-5.0 μL water droplet. Advancing and receding water contact angles were measured by automatically adding and removing water from the substrate, respectively. All contact angle values were averaged over three different spots on each sample. For roll-off angle measurement, the substrate was placed on a custom-designed stage with protractor attached to it and a 10 μL water droplet was used. All roll-off angle values were averaged over three different measurements on each sample. The morphologies of the NP films, which were sputter-coated with gold, were imaged by FEI Quanta 600 FEG Environmental Scanning Electron Microscopy (ESEM). The surface topography of the samples was imaged by Dimension 3000 Atomic Force Microscopy from Digital Instruments, with a Si₃N₄ cantilever in tapping mode. The root mean square (RMS) roughness values were calculated from 5 μm×5 μm images using nanoscope VII software. The optical transparency of the glass substrates was measured using a Varian UV-Vis-NIR Cary 5000 spectrophotometer. The thickness of the low surface energy material deposited on a Si wafer was measured using a Rudolph Research AutoEL-II null ellipsometer and the values are averaged over three different spots. The refractive index of the low surface energy material was assumed to be 1.5.

Without being bound to any particular theory, wetting behavior may depend on both surface chemistry and surface topography. There are two distinct models by Wenzel and Cassie-Baxter. In Wenzel's model, roughness effectively increases the actual surface area. The apparent Wenzel contact angle, θ^{w}, on a rough surface is defined as cos θ^{w}=r cos θ₀ (eq. 1), where r is the roughness factor and defined as the ratio of actual surface area over the apparent surface area, and θ₀ is the equilibrium contact angle on a flat surface or the Young's contact angle. On a hydrophobic surface (θ₀>90°), θ^{w} is increased by roughness. When the substrate is intrinsically hydrophilic (θ₀<90°), solid-liquid interaction is favored; θ^{w} will be decreased by roughness, resulting in spontaneous spreading on the rough surface. In the Cassie-Baxter model, it is considered that liquid contacts a heterogeneous surface, and the apparent contact angle, θ^{c}, can be described as cos θ^{c}=f₁ cos θ₁+f₂ cos θ₂ (eq. 2), where f₁ and f₂ are fraction of different surface components (f₁+f₂=1), θ₁ and θ₂ are Young's contact on the homogeneous surface of each components respectively. When air is trapped in the grooves of the rough surface, the surface is considered to be a composite surface of solid and air, and eq. 2 becomes cos θ^{c}=f(cos θₒ+1)−1 (eq. 3) where f is the fraction of liquid-solid contact. θ^{c} increases with decreasing f as more air is trapped between the grooves of the rough surface. To achieve superhydrophobicity, dual-scale roughness may be advantageous together with the an intrinsic hydrophobic nature of the substrate.

Two general strategies have been used to create a superhydrophobic surface: (1) introduction of surface roughness or porosity on a low surface energy material, and (2) creation of roughness on surface, followed by deposition of a low surface energy material on top of it. The first approach does not require post-treatment of the substrate; the procedure of creating roughness from a low surface energy material may include one or more steps. The second approach is also versatile, for example, using nanoparticle assemblies. A post-treatment of the rough surface with a thin layer of hydrophobic coating is useful, especially if the original substrate is not hydrophobic. Deposition of low-surface-energy coating may prevent the exposure of hydrophilic regions, and thus modify the liquid-solid surface interface.

It is useful, though not essential, to perform multistep washing and centrifugation to ensure complete remolval of the unreacted and partially functionalized silican nanoparticless, which would otherwise become pinning sites of the ater molecules in the later wetting studies. The obtained F—SiO₂ nanoparticles could form stable dispersion in nonpolar solvents. Thus, Novec 7300 and decafluoropentane can be used for spin-casting and dip-coating, respectively.

To reduce post-treatment processes, one may control the surface coverage of the hydrophobic nanoparticles to minimize exposure of the underlying substrate, especially when the substrate is relatively hydrophilic. It is demonstrated that silica nanoparticles dip-coated on a flat substrate are random and non-close-packed, whereas spin-coating may lead to close-packed colloidal crystals due to shear-induced ordering. To obtain high surface coverage, one may desire to spin coat the nanoparticles.

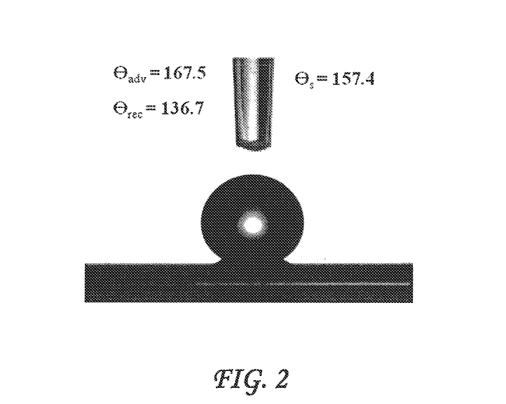

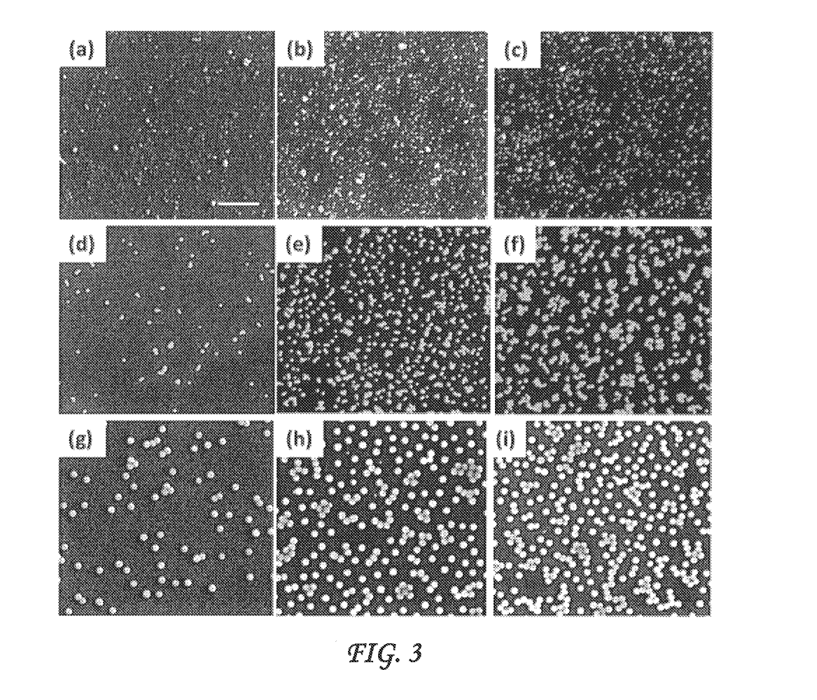

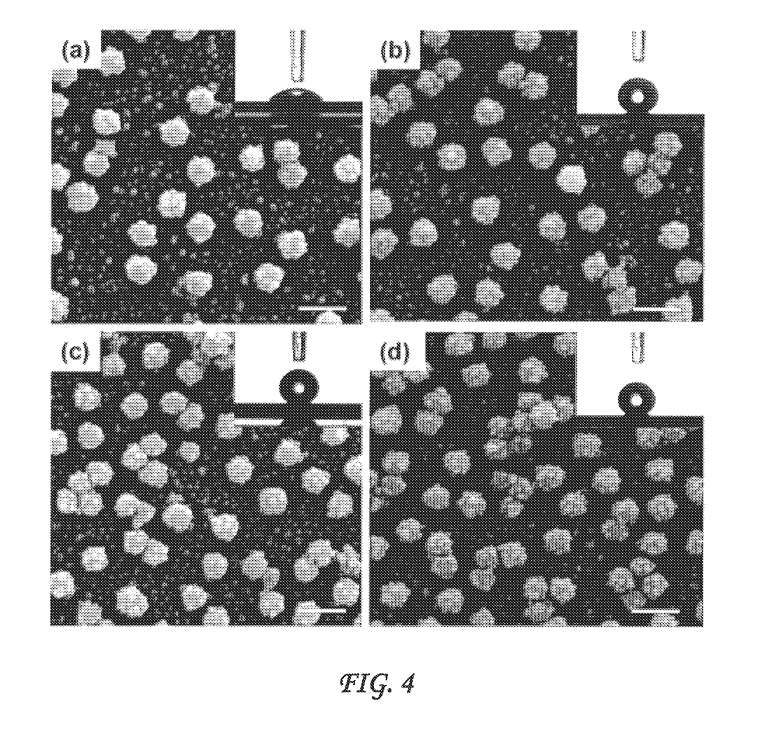

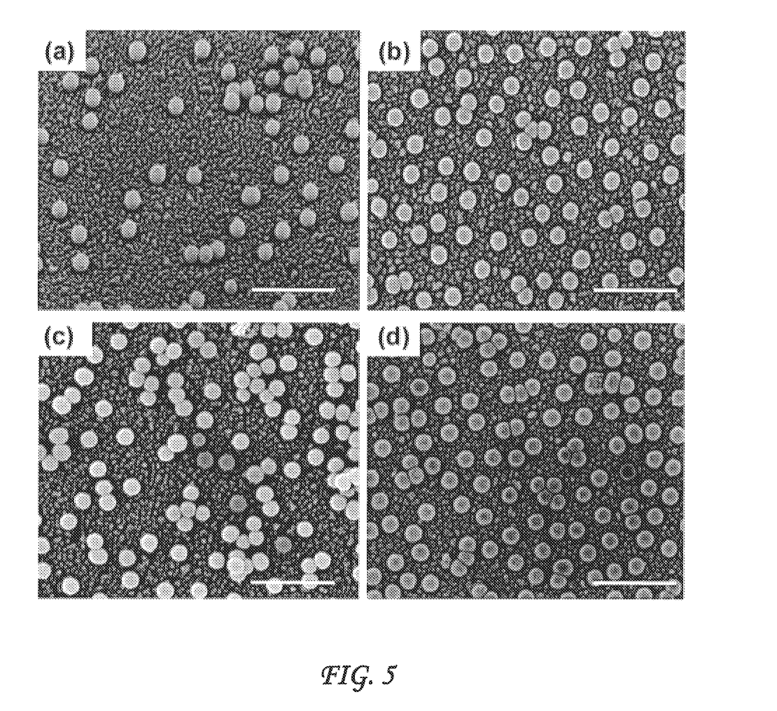

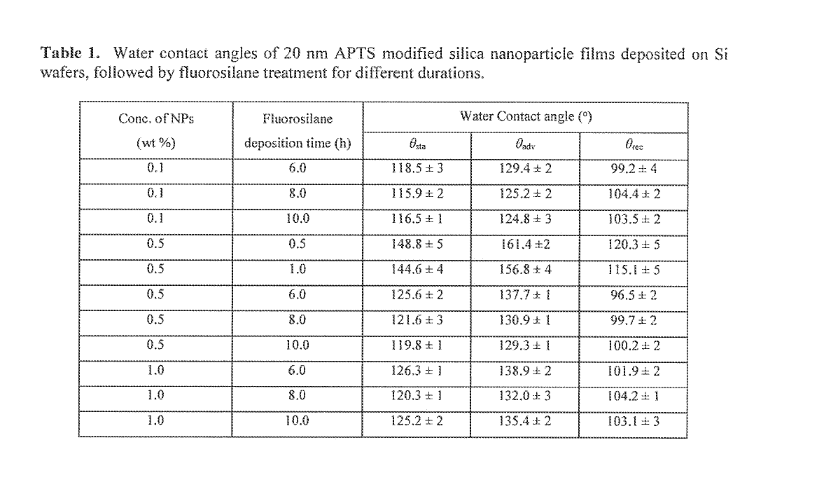

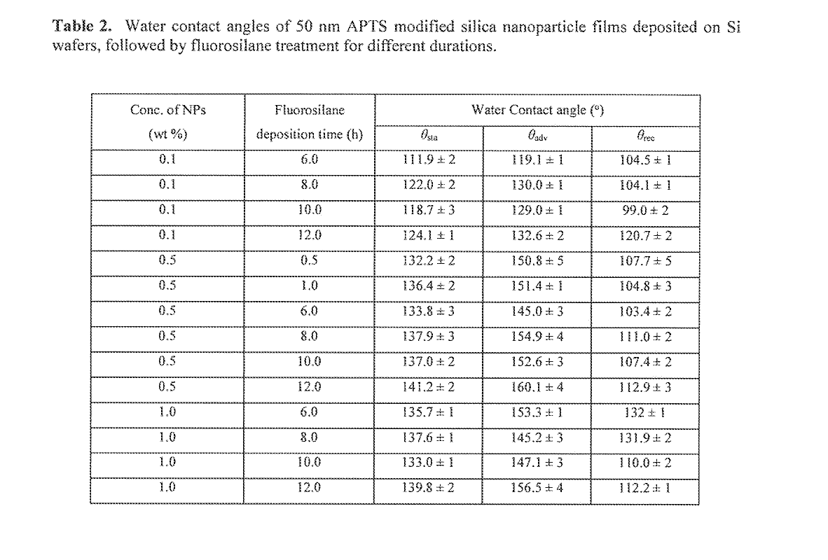

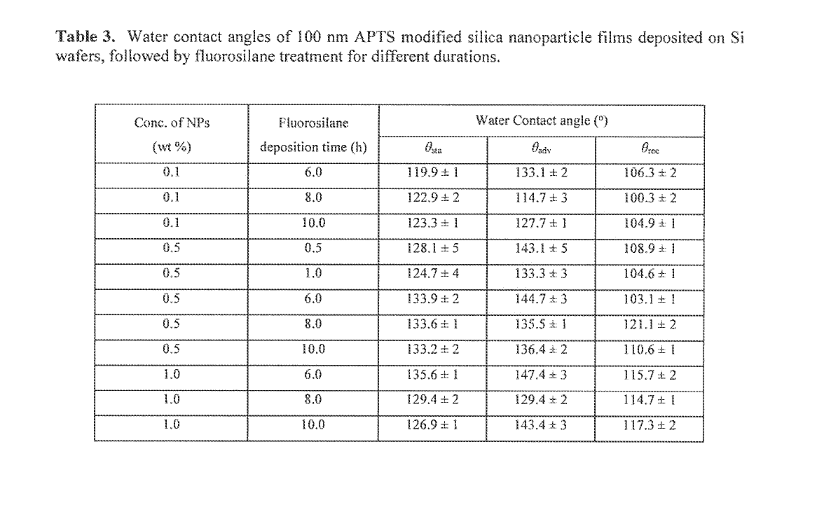

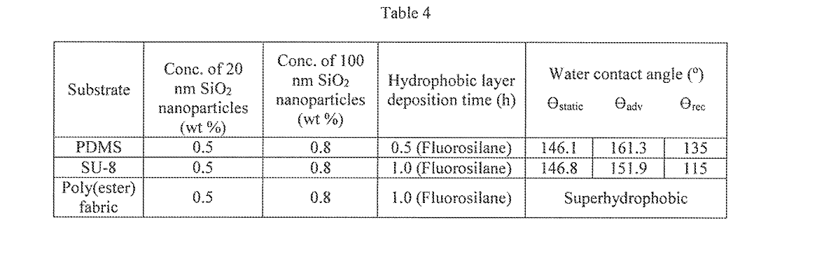

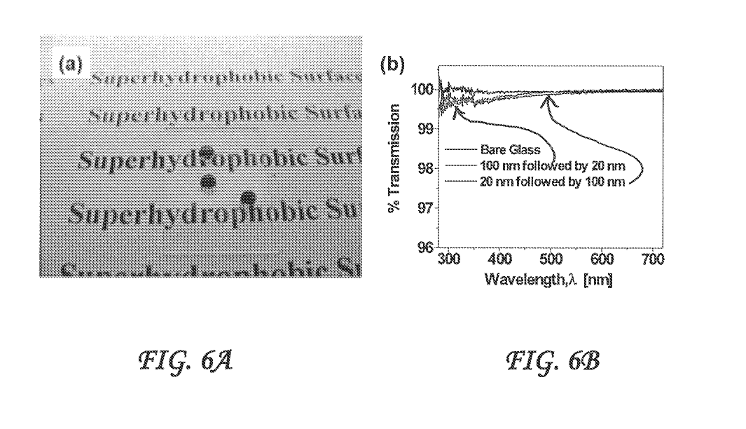

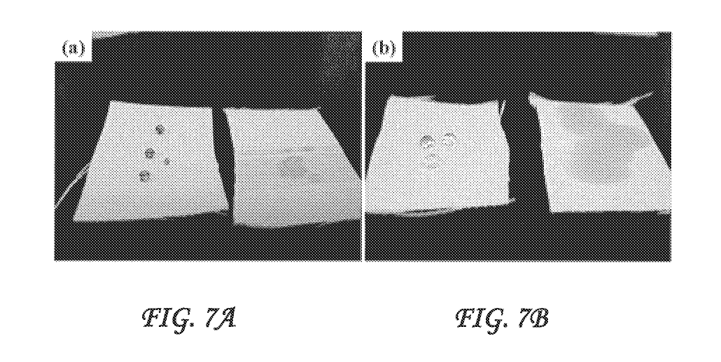

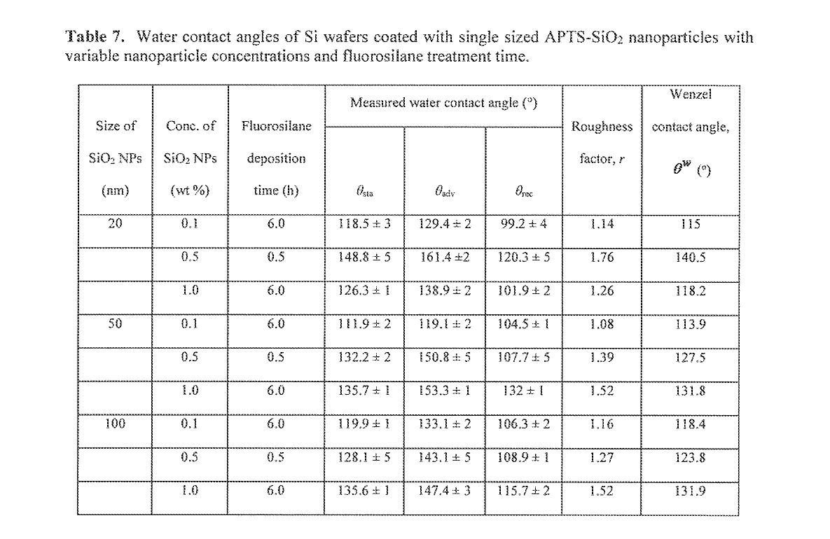

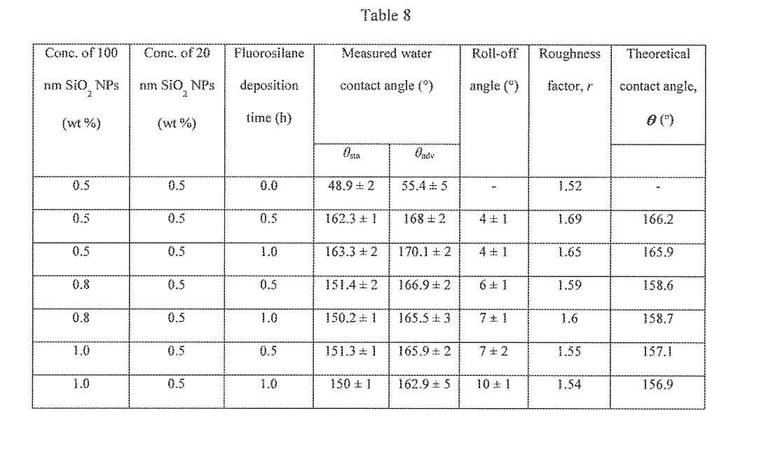

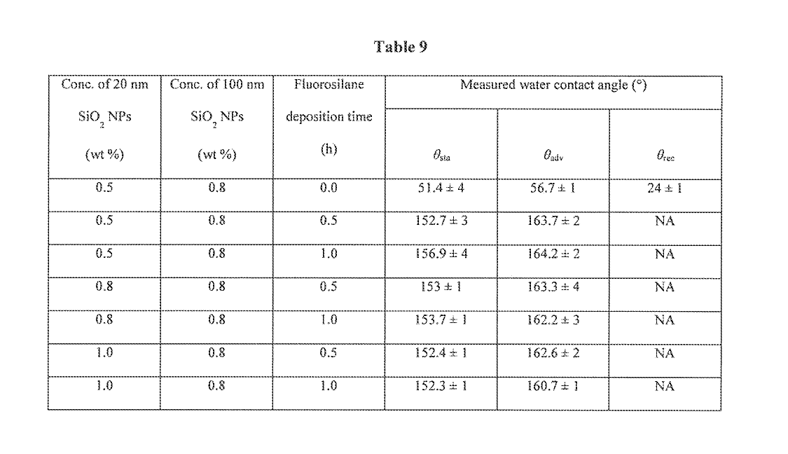

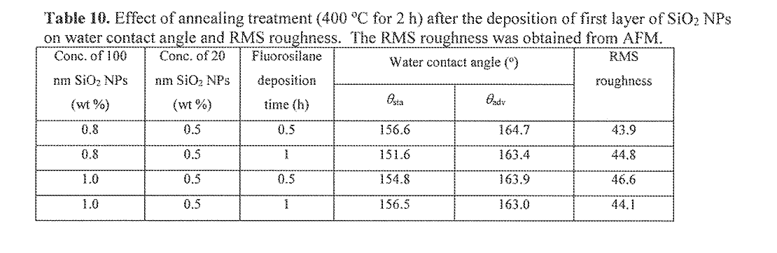

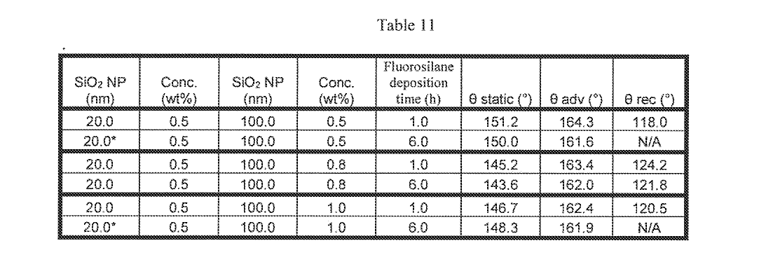

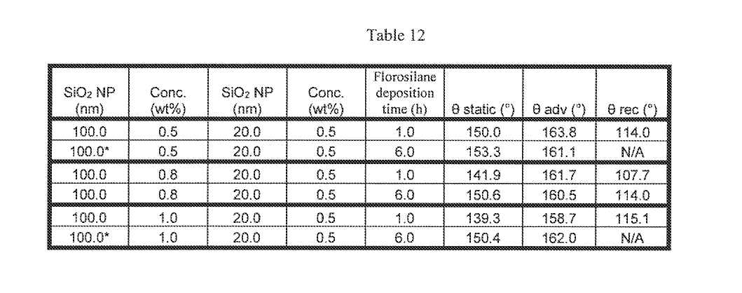

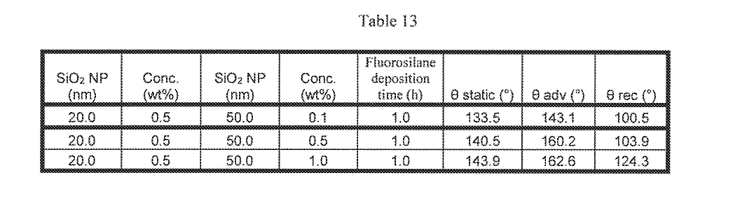

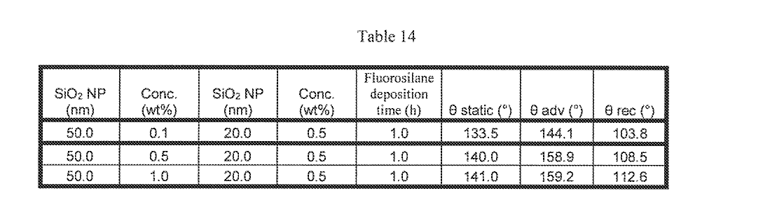

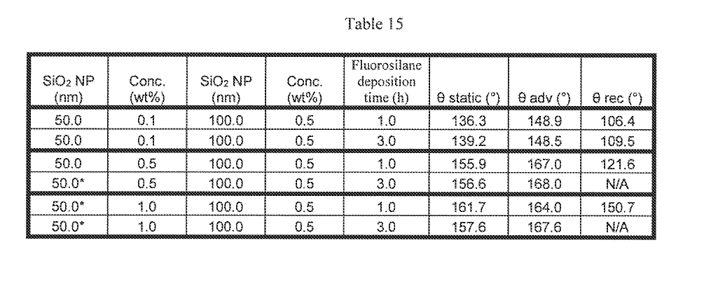

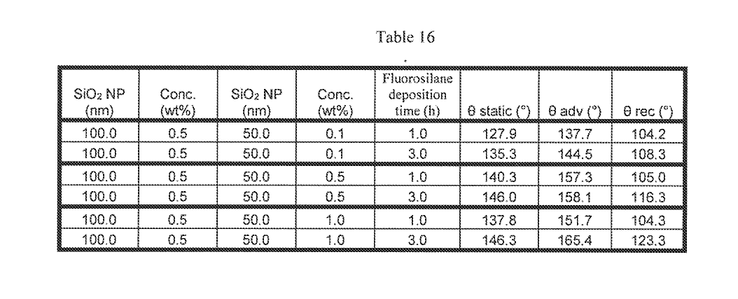

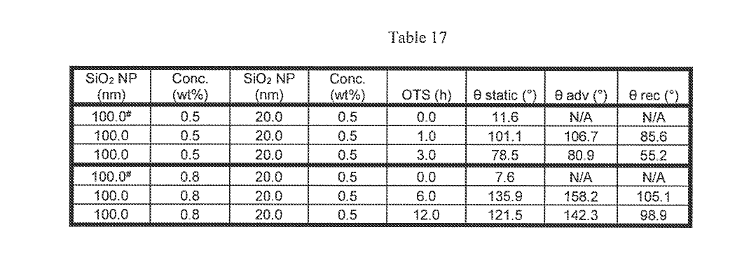

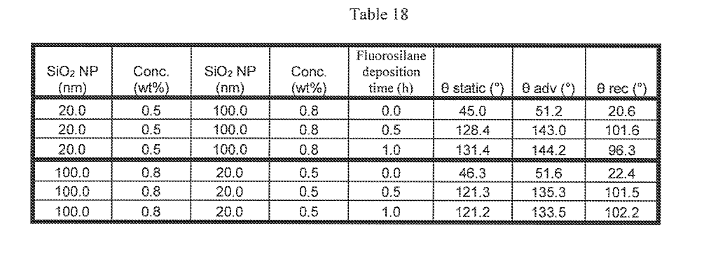

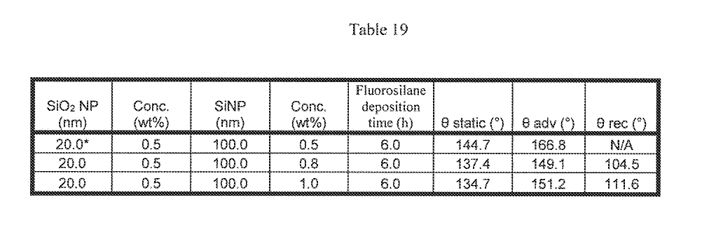

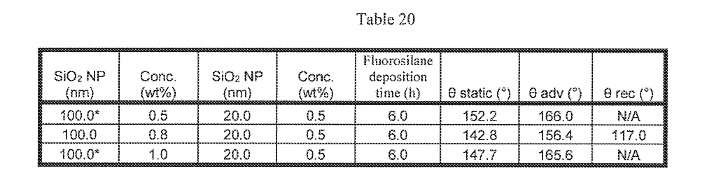

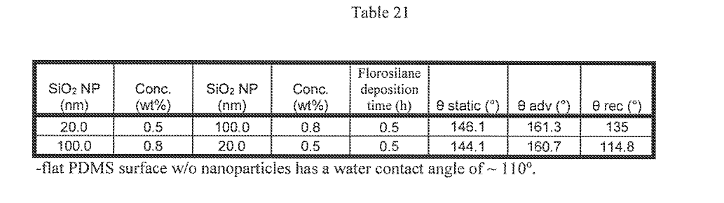

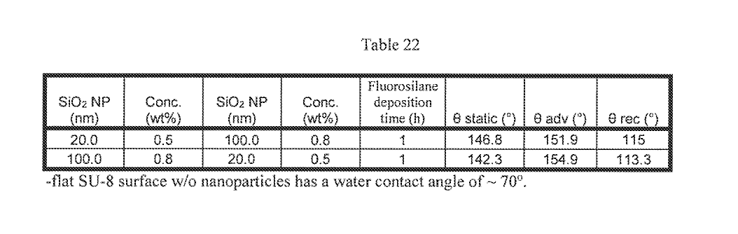

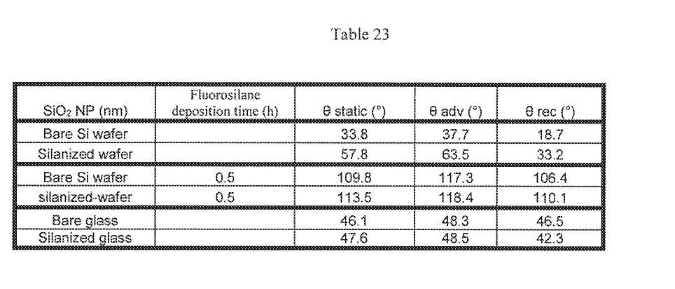

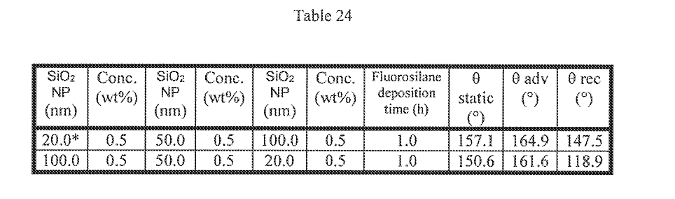

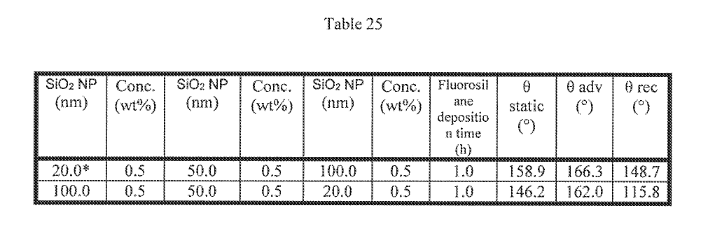

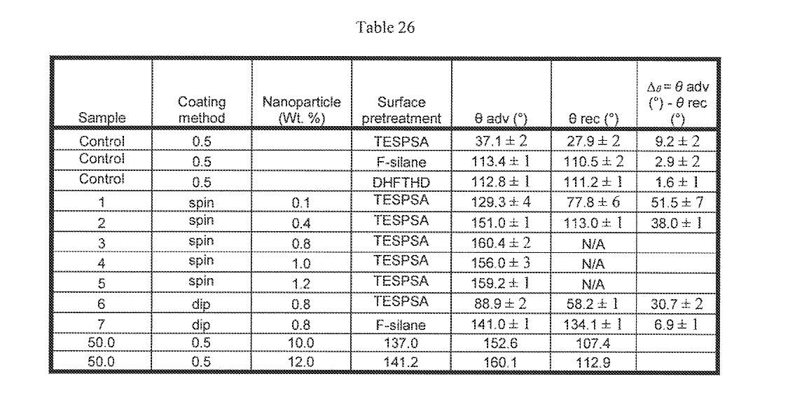

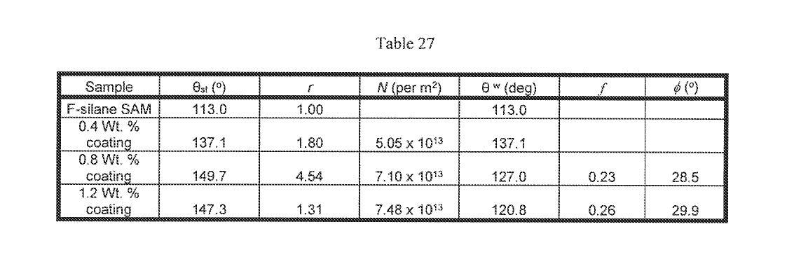

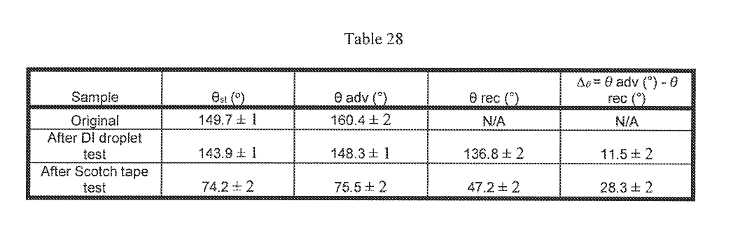

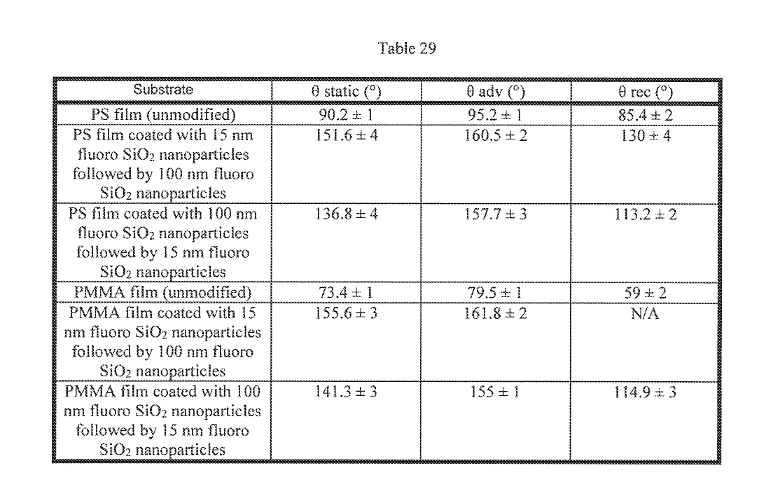

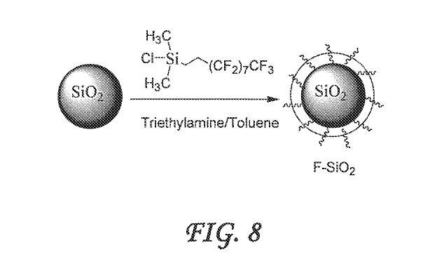

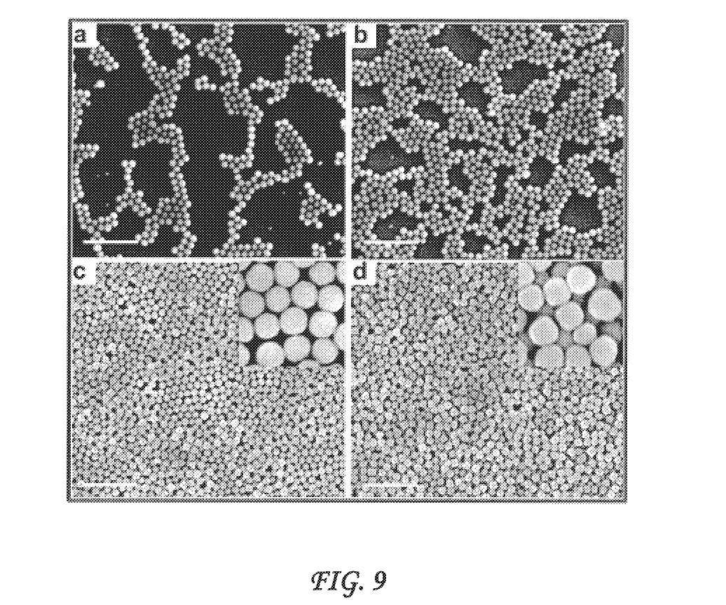

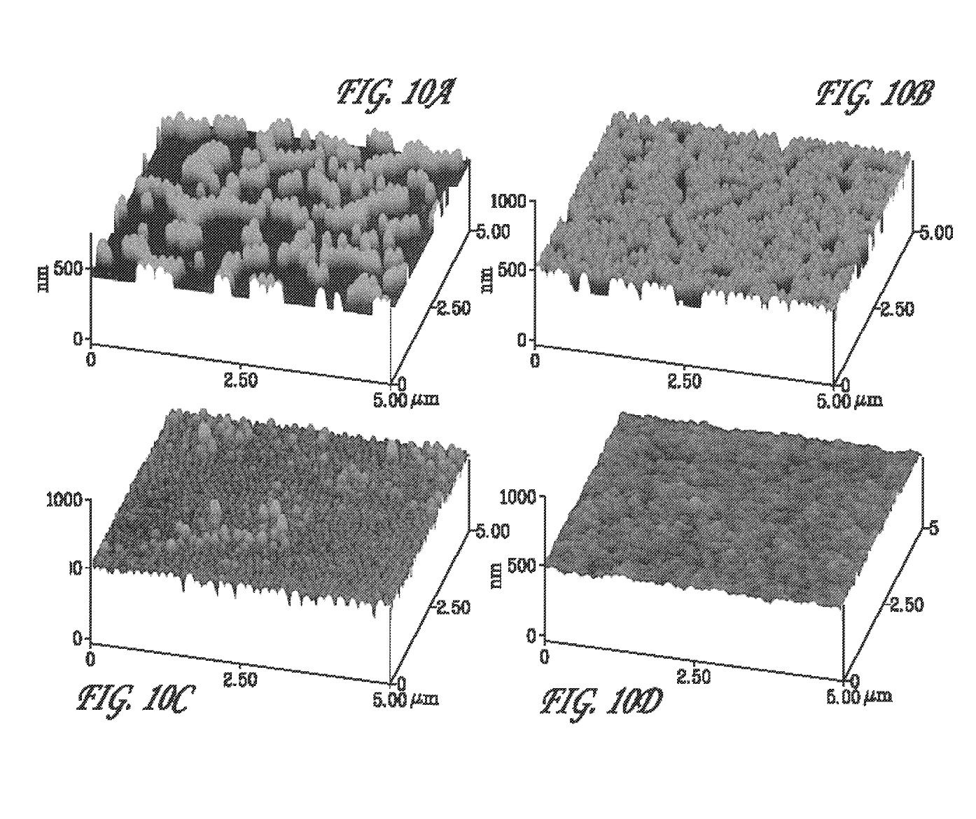

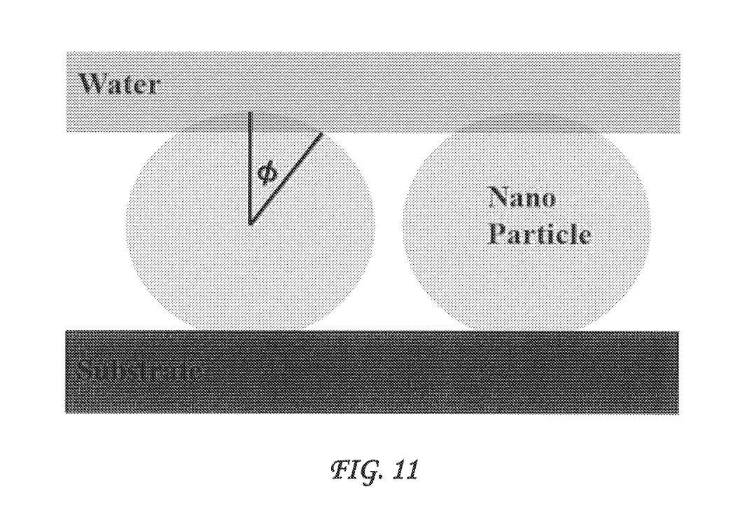

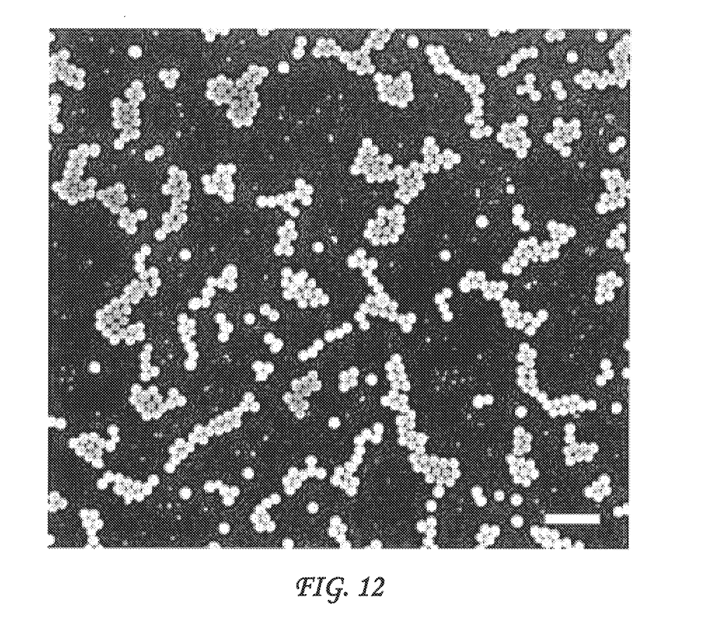

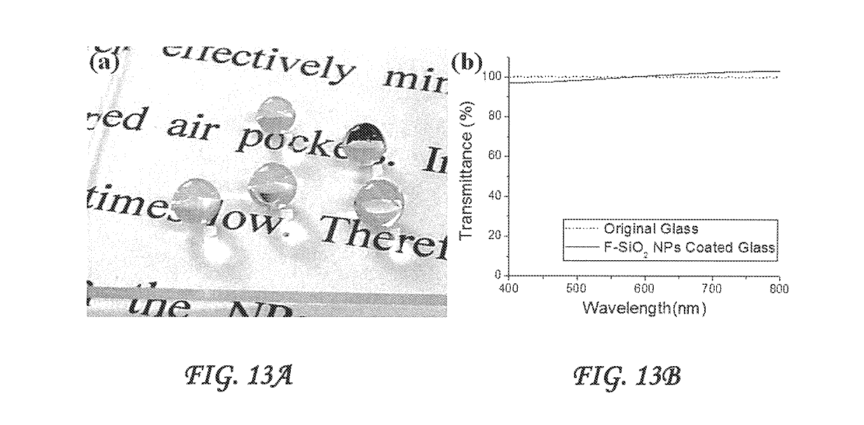

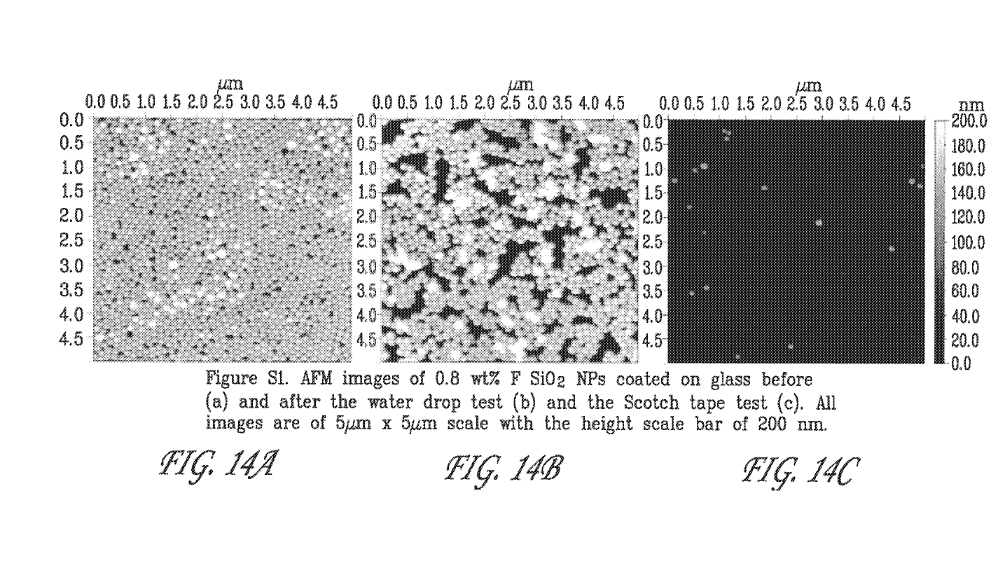

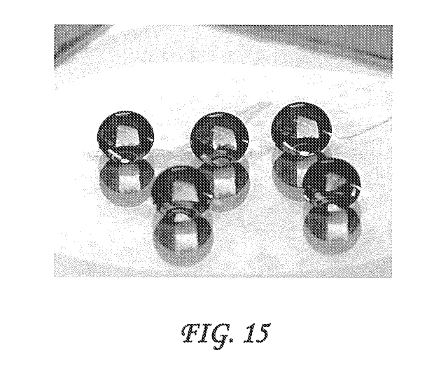

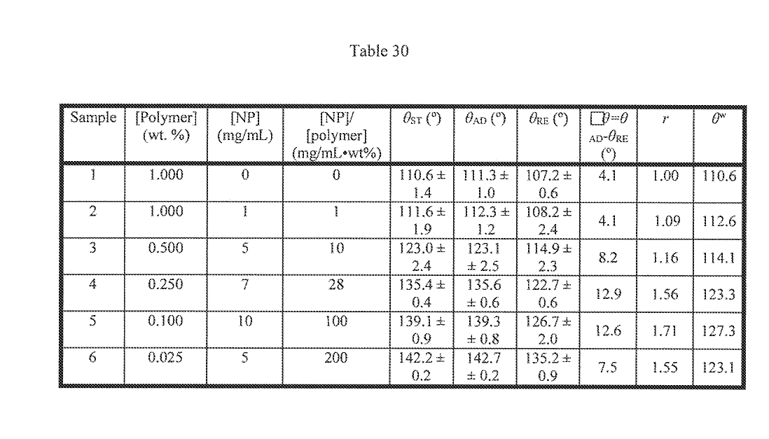

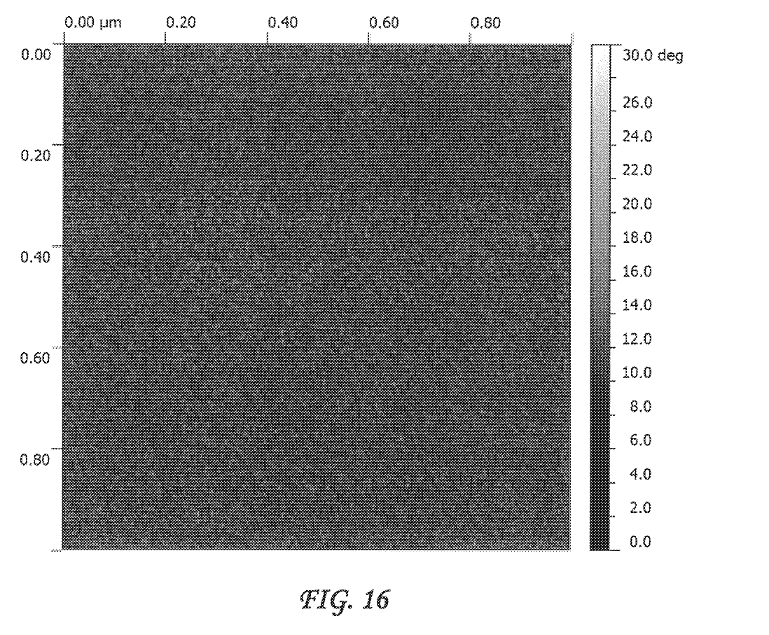

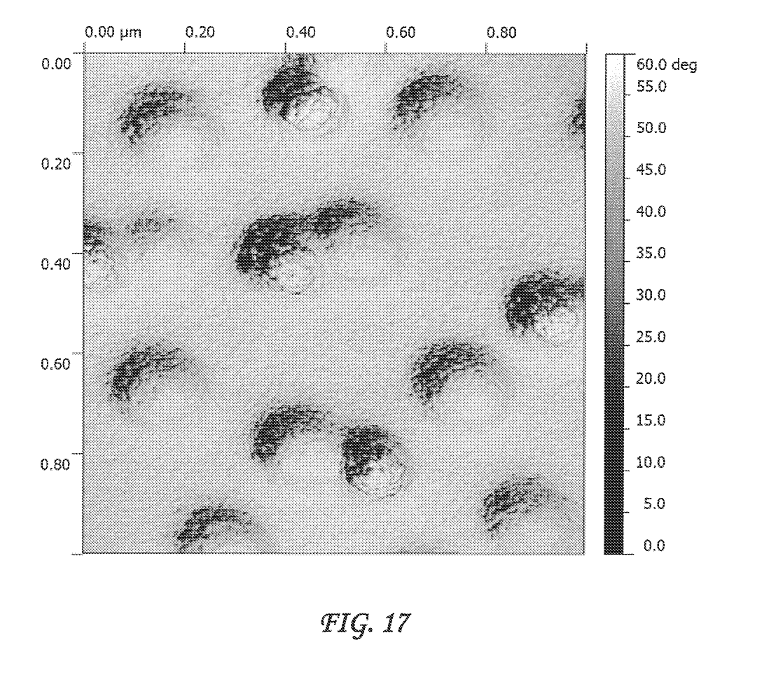

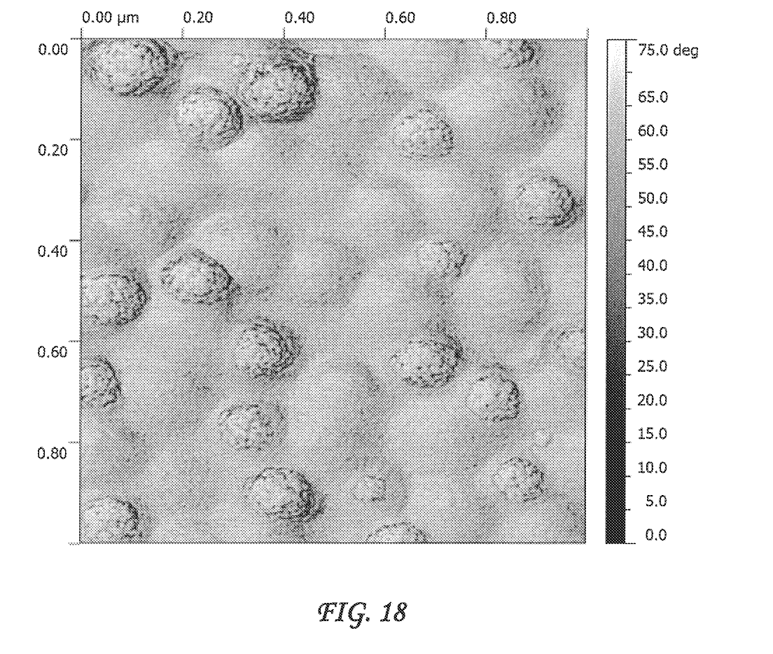

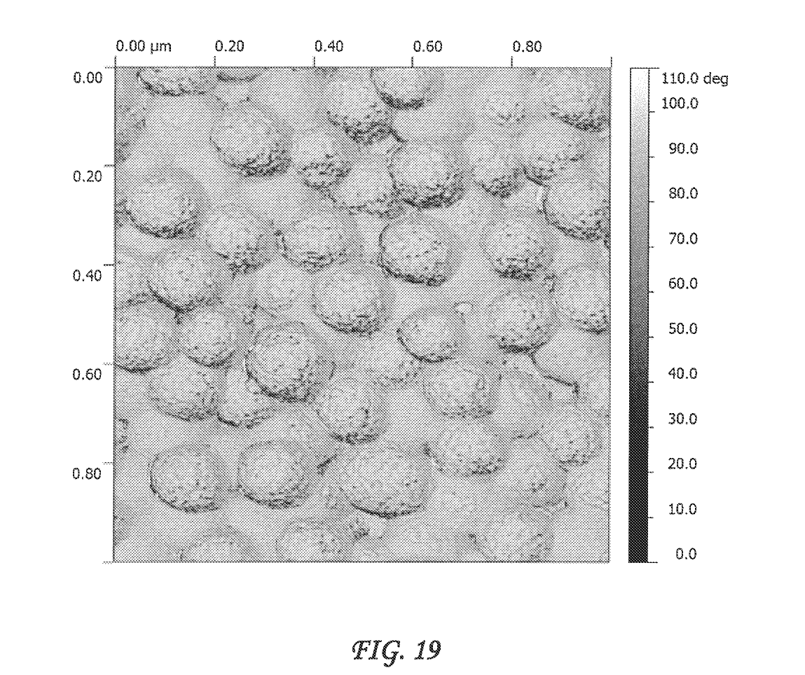

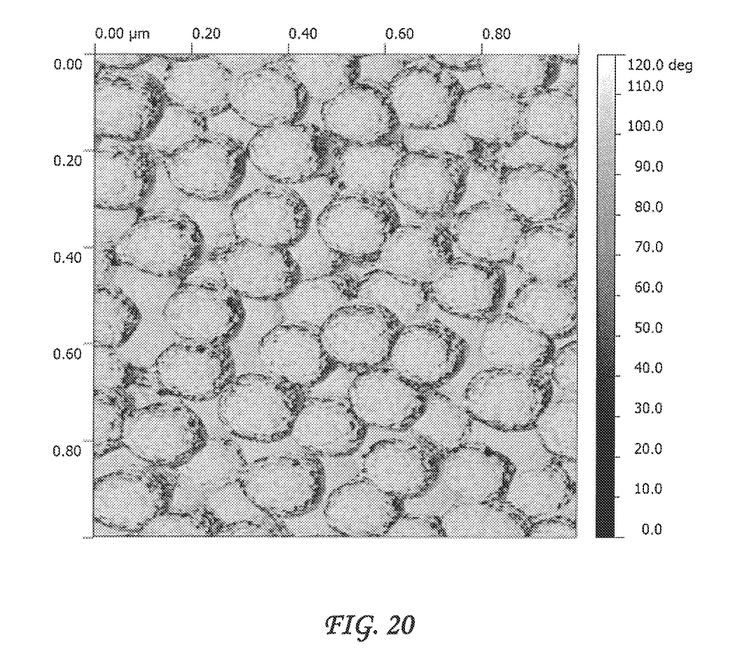

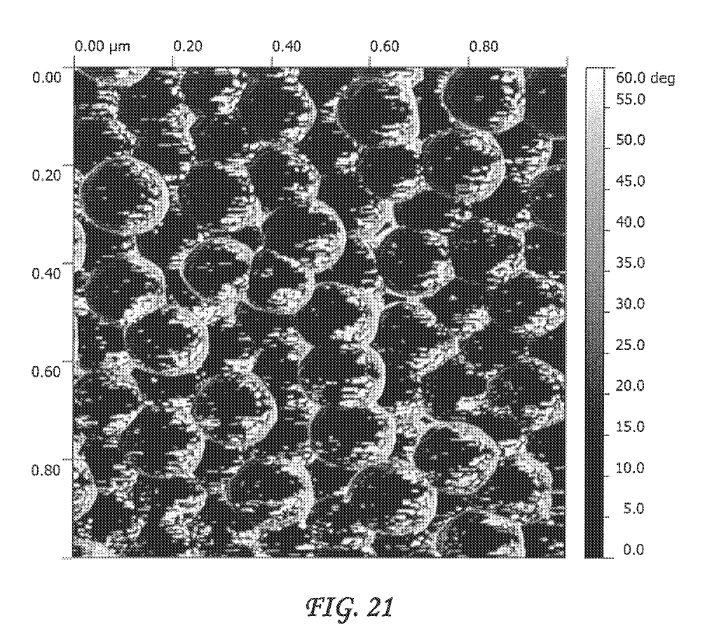

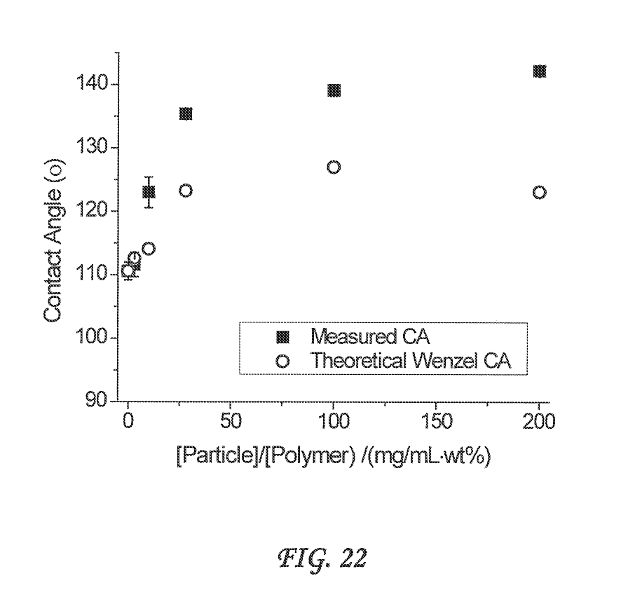

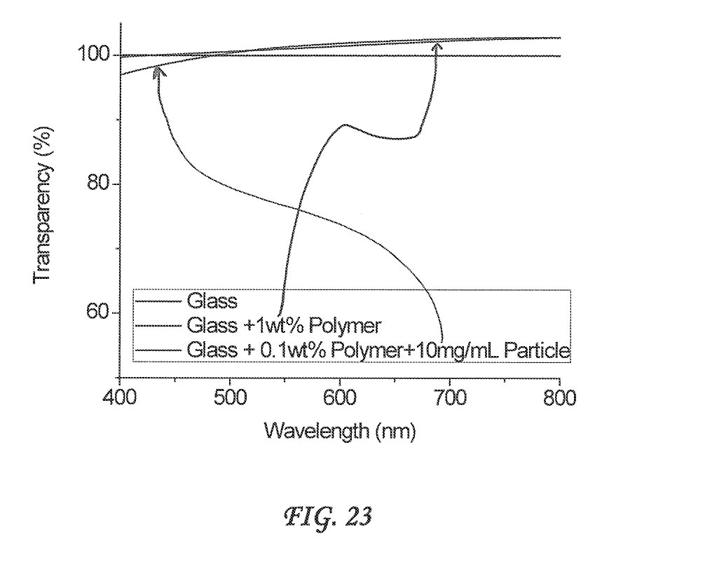

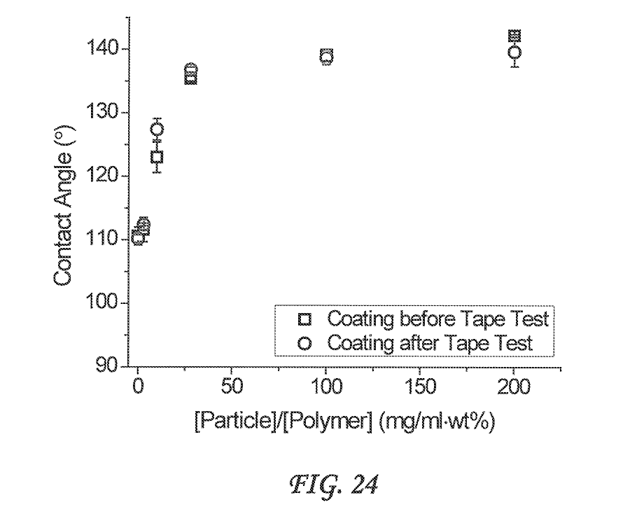

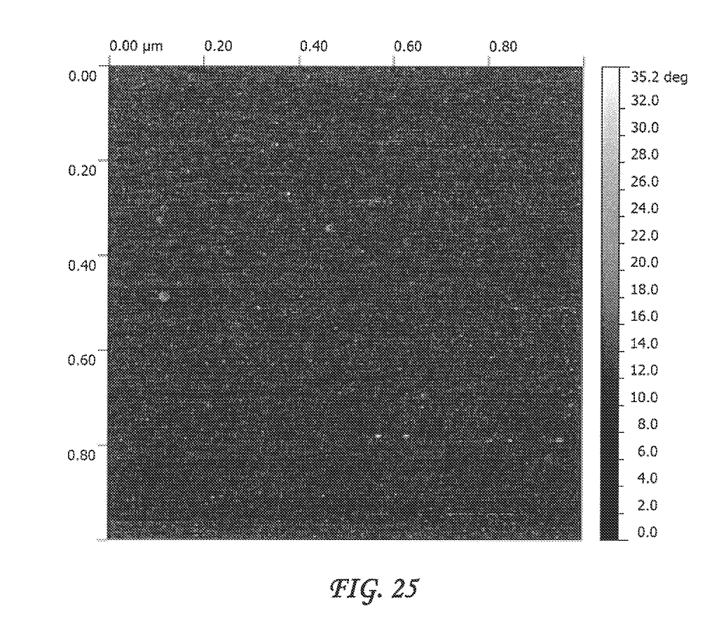

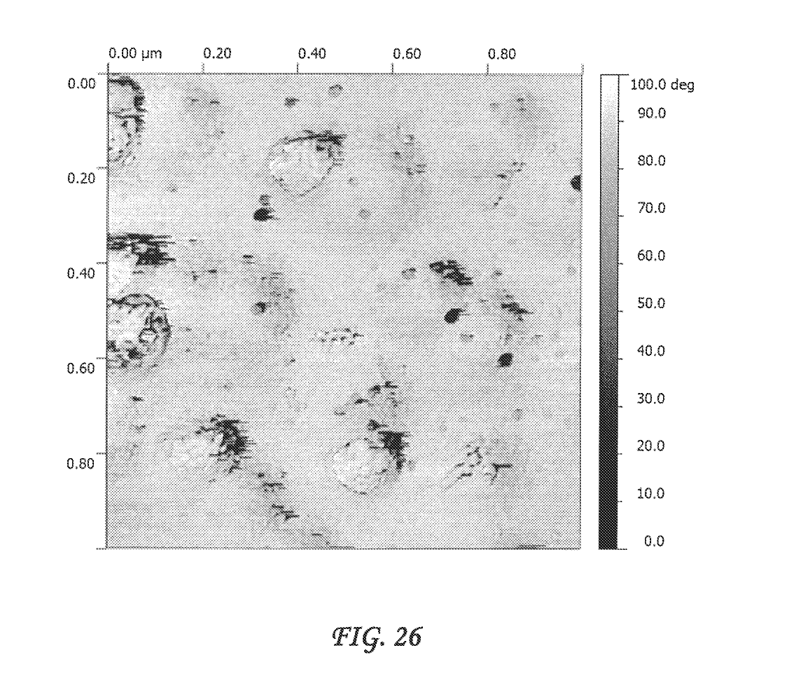

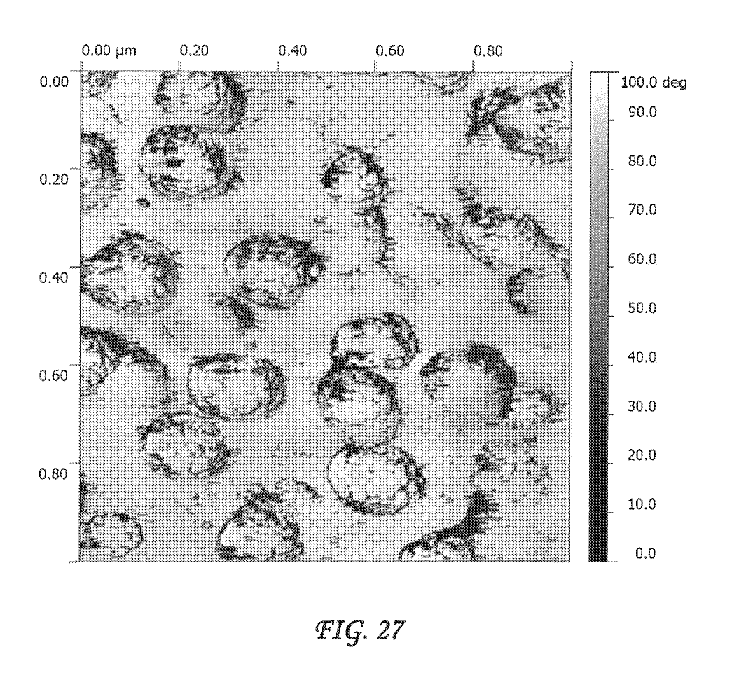

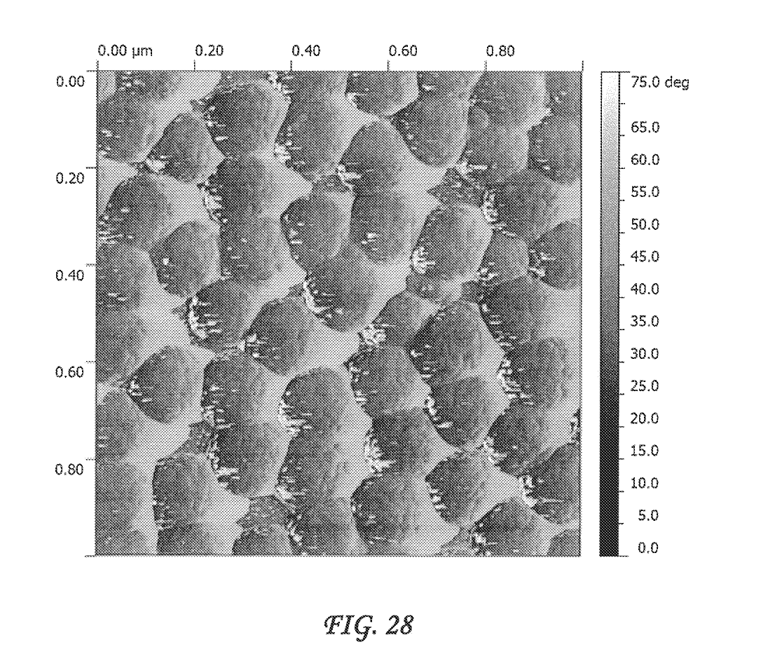

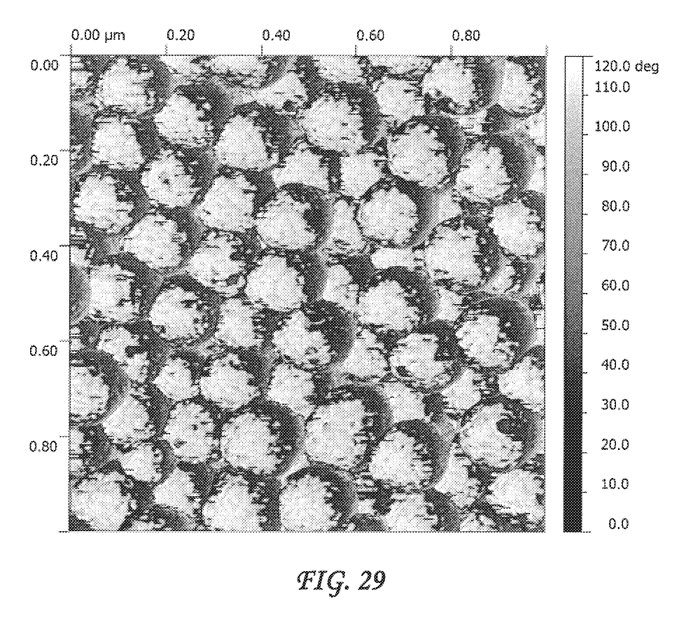

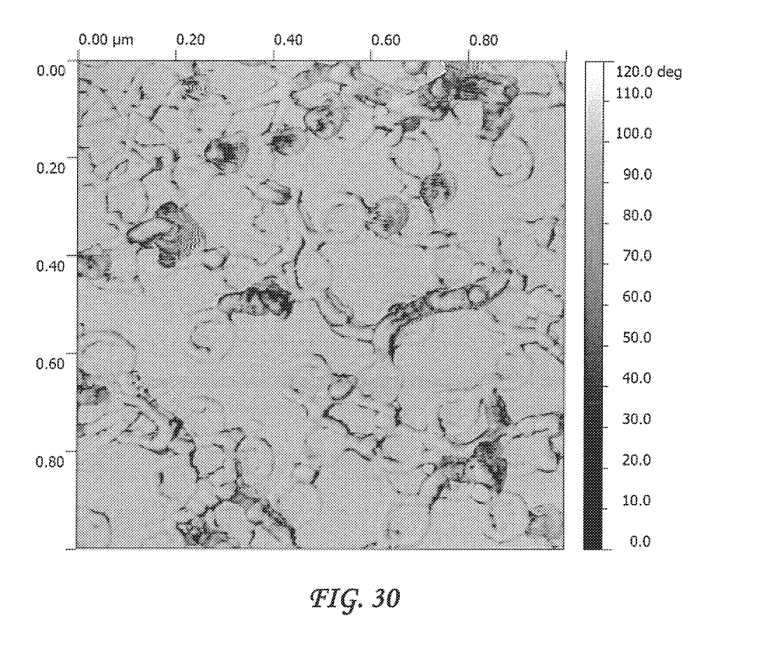

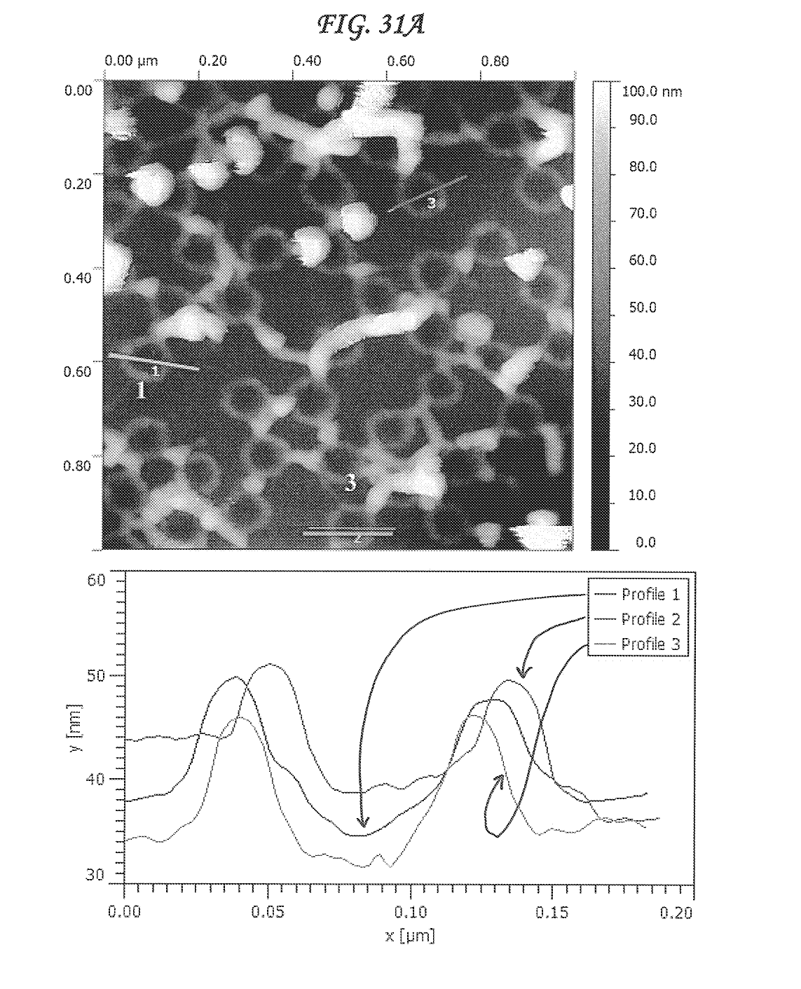

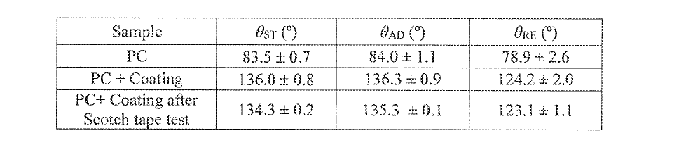

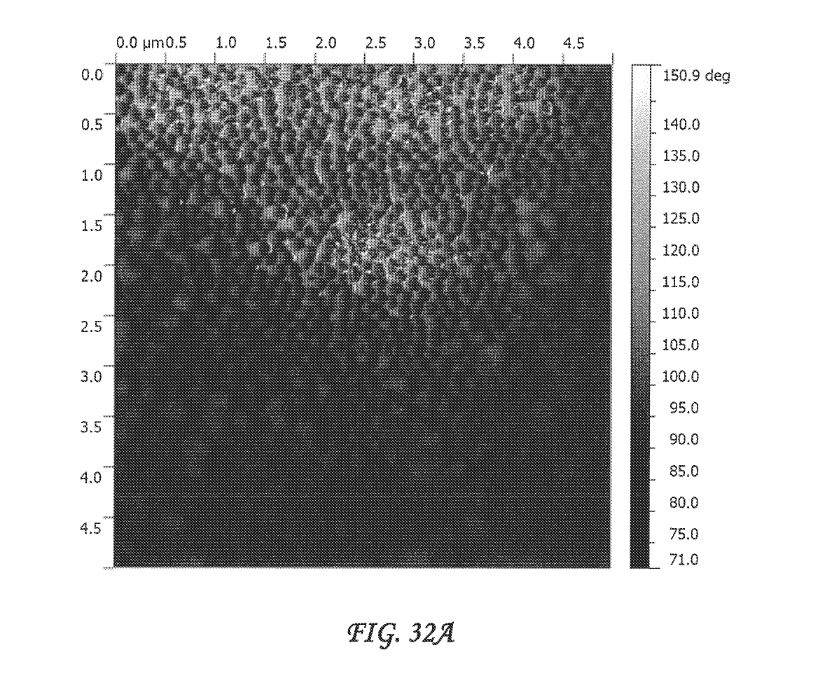

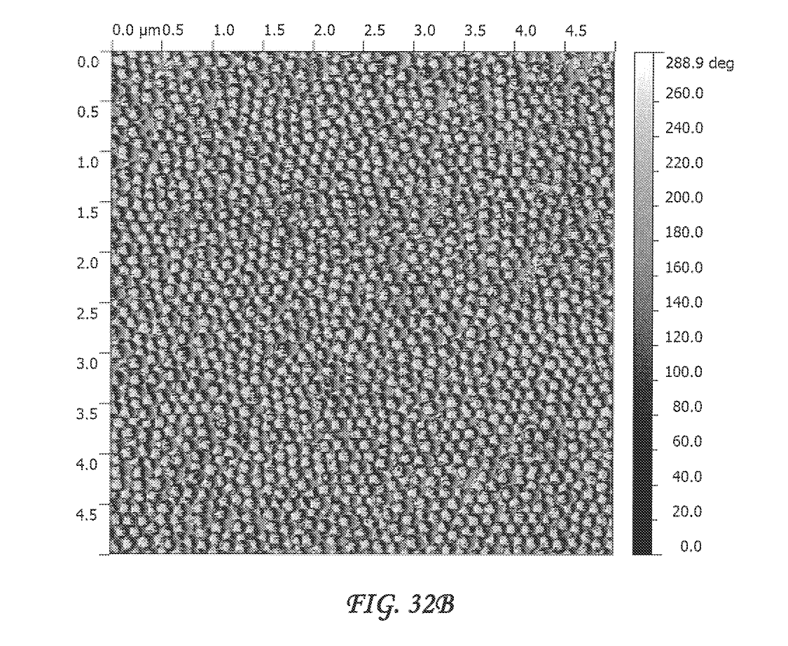

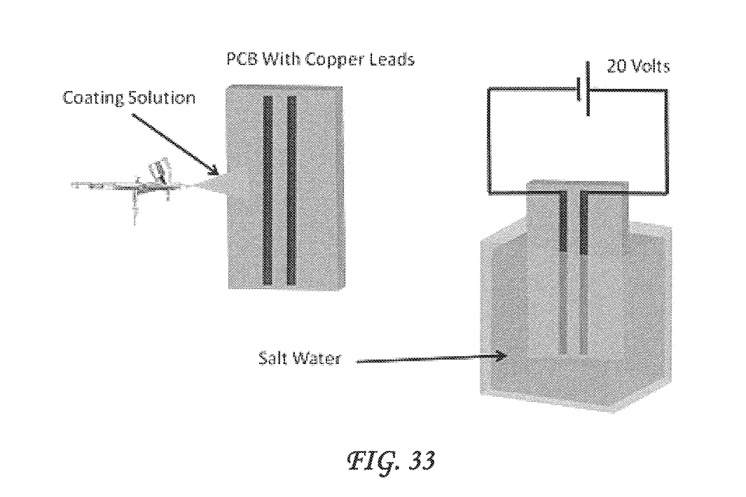

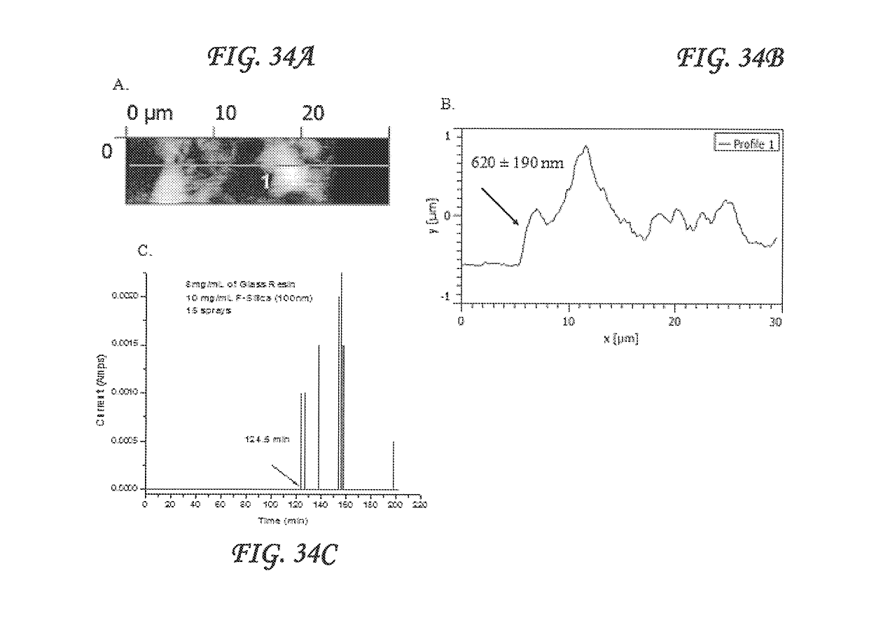

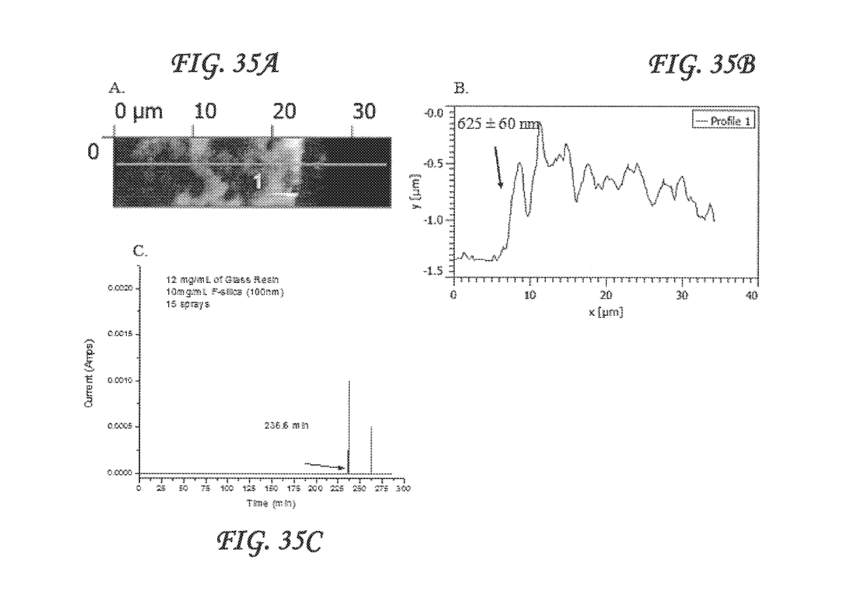

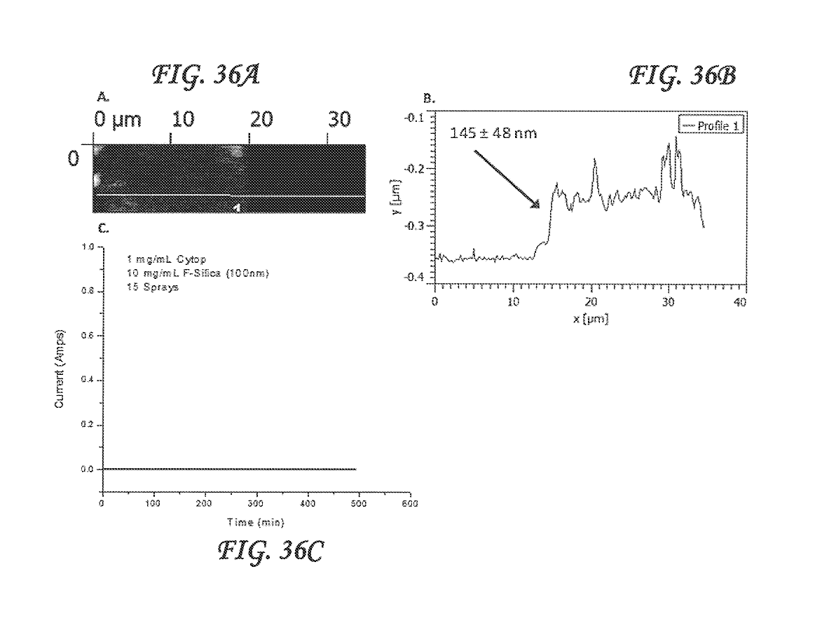

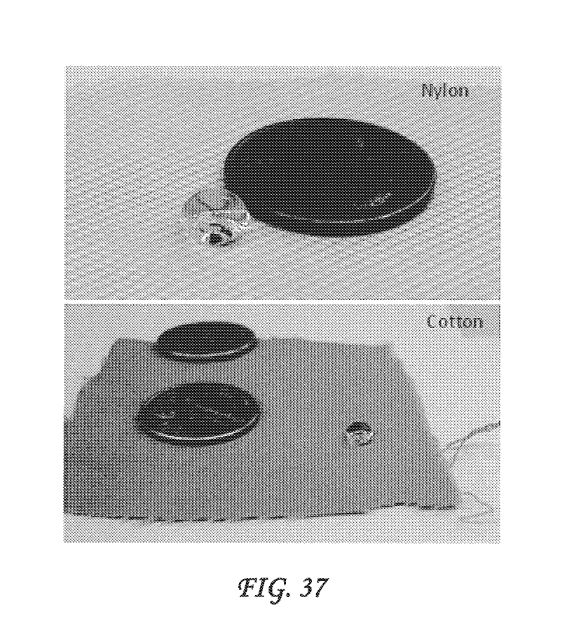

The dynamic water contact angles on coated Si substrates are summarized in Tables 1-4. Increase of water contact angle and decrease of contact angle hysteresis were observed on spin-coated films when the nanoparticles concentration was increased, suggesting a transition from Wenzel state to Cassie-Baxter nonwetting state. When the concentration of F—SiO₂ NP was increased to ≧0.8 wt %, the spin-coated surface became superhydrohpobic with an advancing water contact angle>150° and the receding contact angle were not measurable due to high mobility of the water droplets. SEM images (FIG. 7) revealed that when increasing NP concentration, the NP assembly changed from random, nonclose packed (0.1 wt % and 0.4 wt %) to nearly close-packed (≧0.8 wt %), by which the substrate was fully covered. In addition, the 0.8 wt % NP film had a few second layer nanoparticles covered on top of the first layer, whereas 1.2 wt % NP film appeared to have much more double-layered nanoparticles (see FIG. 2c, d).

The surface coverage indicated by AFM images agrees with that from SEM images very well (FIG. 9). In addition, AFM images suggest that the surface roughness, rms, decreases when increasing the NP coverage on surface, from 51.20 nm (0.1 wt %) to 49.70 nm (0.4 wt %) to 25.80 nm (0.8 wt %) to 13.90 nm (1.2 wt %).

The roughness factor, r, is estimated from AFM data to predict the Wenzel water contact angle as summarized in Table 5. When the concentration of nanoparticles was greater than 0.4 wt %, surface was almost covered by F—SiO₂ nanoparticles. In this case, the theoretical Wenzel contact angle, θ^{w}, can be estimated using the water contact angle on F-silane SAM as θ₀ in eq 1.

By comparing the measured θₛₜ and theoretical Wenzel angle, θ^{w}, one can see that when NP concentration is 0.4 wt %, the measured value is close to the predicted Wenzel contact angle. When nanoparticles concentration was greater than 0.4 wt %, the measured contact angle was much higher than the predicted Wenzel contact angle, suggesting that water did not penetrate grooves between nanoparticles, that is, Cassie-Baxter nonwetting behavior as shown in FIG. 10.

To confirm this, one may estimate the azimuthal angle, φ (see FIG. 10), representing the level of water wetting on the particle surface. By assuming that the wetting line holds at the same level and the liquid penetration between particles can be ignored, the filling fraction can be expressed as:

$$f = \frac{2 π {R}^{2} ( 1 - cos ϕ ) N}{2 π {R}^{2} ( 1 - cos ϕ ) N + 1 ( 1 - {π ( R sin ϕ )}^{2} N )}$$

where R is the radius of nanoparticles in average (˜65 nm), N is the number density of nanoparticles (see Table 2). R and N were measured from AFM images. For samples with nanoparticles=0.8 wt % and 1.2 wt %, f was calculated using the Cassie-Baxter model, eq 3. Then, using eq 4, φ was obtained as 28.5° and 29.9°, respectively. The results indicate the water merely wets the top area of nanoparticles, in agreement with the Cassie-Baxter nonwetting behavior from the close-packed F—SiO₂ NP films.

The surface morphologies of nanoparticle coatings at different concentrations revealed by SEM and AFM images corroborate with the water contact angle results. At low nanoparticle concentration, nanoparticles were not able to cover the underlying substrate. Because TESPSA-treated Si is hydrophilic with a static water contact angle of 36.2±1°, from eq 2, one can see that large fraction of exposed TESPSA surface, f₁, will lead to wettable surface (with large contact angle hysteresis), even if it has relatively large water contact angle. When gradually decreasing f₁ and increasing f₂ (fraction of hydrophobic F—SiO₂ NP), the water contact angle increased while the contact angle hysteresis decreased. When the surface was completely covered by the F—SiO₂ NP, the surface became Cassie-Baxter nonwettable surface with air pocket trapped in-between F—SiO₂ nanoparticles (concentration≧0.8 wt %) and the water contact angle should be described by eq 3. According to eq 3, increasing f will decrease the apparent water CA. In Table 4, one may observe a slight decrease of the apparent water CA in samples 3, 4, and 5 when increasing the NP concentration, although the NP films remained superhydrophobic. However, at NP concentration≧0.8 wt. %, their assembly became close-packed. Further increase in the NP concentration in spin-coating only led to building up of a second layer of nanoparticles, as revealed by SEM images seen in FIG. 8, which did not change much of the apparent water contact angle and contact angle hysteresis.

Once the surface became superhydrophobic, the water droplet tended to stick to the goniometer needle rather than the substrate. To confirm the superhydrophobicity and low flow resistance of the surface, one may measure water droplet roll-off angle, which is defined as the tilt angle when the liquid drop starts to move on a surface. A small tilt angle (less than 5°) was observed on all superhydrophobic surfaces.

The spacing between the rough textures is important to the wetting/nonwetting behaviors. It has been shown that increasing the distance between microposts increases the receding contact angles up to a certain point, followed by a decrease of the receding contact angle. This can be explained by the increase of the solid-liquid contact, thereby increasing the contact angle hysteresis. Likewise, when nanoparticles are far apart on the substrate, water can impregnate between the nanoparticles and becomes pinned on the exposed hydrophilic substrate, leading to large contact angle hysteresis even though the advancing water contact angle is high. When the coverage of hydrophobic particles is increased and begin to form the second layers (see inset of FIG. 2d), even if the second layer is not perfectly close-packed, the underlying substrate will no longer be in direct contact with water, leaving air trapped between and underneath the particles to achieve highly mobile contact line at the NP-air-water interface.

To support the hypothesis on the effect of packing density of F—SiO₂ Nanoparticles to nonwettability, dip-coating was performed of 0.8 wt % F—SiO₂ NP in decafluoropentane on TESPSA treated Si. The advancing water contact angle was 88.9±2° (see Table 4, sample 6) with contact angle hysteresis of ˜30°, which was in sharp contrast to an advancing water contact angle of 160.4±2° and nonmeasurable receding water contact angle from the spin-coated sample of the same NP concentration. SEM images confirmed the difference in surface coverage of F—SiO₂ nanoparticles: whereas the spin-coated nanoparticles (FIG. 8c) were nearly close-packed to cover the whole surface, the dip-coated Nanoparticles (FIG. 11) were loosely deposited on the substrate, and the surface coverage was even lower than that of spin-coated film from 0.1 wt % nanoparticles (see FIG. 8a). Consistent with the low surface coverage, the dip-coated film from 0.8 wt % NP solution showed smaller water contact angle than that of 0.1 wt % spin-coated NP film. In general, one may observe that the packing density of F—SiO₂ Nanoparticles from spin-coating were much higher than that from dip-coating. This may be explained by the relatively poor wettability of F—SiO₂ NP/decafluoropentane solution on TESPSA treated, hydrophilic Si when dip-coating the Nanoparticles. In the case of spin-coating, however, the high shear force could overcome surface effect, forcing more Nanoparticles to pack on TESPSA-treated Si.

To further confirm that the exposed hydrophilic substrate, because of the loosely packed nanoparticles, is the main reason for decreased water contact angle and increased contact angle hysteresis, F—SiO₂ nanoparticles were dip-coated (0.8 wt %) on a hydrophobic surface, F-silane-treated Si (θ_{adv}=113.4±1°, θ_{rec}=110.5±1°). The water contact angle was found significantly increased while the contact angle hysteresis was decreased: θ_{adv}=141.0±1° and θ_{rec}=134.1±1° (Table 4, sample 7), in comparison to θ_{adv}=88.9±2° and θ_{rec}=58.2±1° from the hydrophilic, TESPSA treated Si (Table 4, sample 6).

Besides achieving superhydrophobicity without any post-treatment steps, the spin coated F—SiO₂ NP film was highly transparent: the underlying text can be clearly seen through the NP coated glass (see FIG. 12a). The high optical transparency was further supported by the UV-vis spectra. Compared to the unmodified glass, F—SiO₂ NP-coated glass showed greater than 95% transmittance in the visible region (FIG. 12b). The coated glass had slightly higher transmittance than the unmodified one at the near IR wavelength because of the lower refractive index contrast at the air-film interface after NP coating.

To investigate the stability of F—SiO₂ NP coating, 0.8 wt % F—SiO₂ nanoparticles were spin-coated on glass without pre- or post-treatment and performed the water drop test and Scotch tape test. The DI water contact remained high (θ_{adv}=148.3±1°) after the drop test, although the hysteresis increased to 11.5±2° (Table 6), implying some particles might be removed. In comparison, water contact angle was significantly decreased to θ_{adv}=75.5±2° after the Scotch tape peeling and the contact angle hysteresis was increased to 28.3±2°. AFM images (FIG. 13) showed that some nanoparticles were removed, leaving a few pinholes after the water drop test, whereas most F—SiO₂ nanoparticles were removed after peeling test, in agreement with contact angle measurement. These results indicate the coating is relatively robust when simply rinsed by water. However, without pre- and post-treatment of the substrate, the adhesion between nanoparticles and glass is not sufficient to sustain stronger mechanical force such as peeling and scratch.

To complete the study, creating superhydrophobic coatings on polymeric substrates was tested, such as poly(methyl methacrylate) (PMMA) and polyester fabric. On these surfaces, oxygen plasma and vapor deposition of a hydrophobic passivation layer (e.g., fluorosilane) are not desirable. After simply spin-coating the 100 nm F—SiO₂ nanoparticles (1.0 wt %) on these substrates, the surface became superhydrophobic. For example, F—SiO₂ NP-coated polyester fabric (FIG. 14) has θ_{adv}=160.5±2° in contrast to θ_{adv}=92.5

Furthermore, a robust, transparent superhydrophobic coating was prepared by one-step coating of a mixture of hydrophobic nanoparticles (e.g. F—SiO₂ NPs) and a low surface energy polymer on a substrate. To achieve superhydrophobicity, both high Young's contact angle (>90°) and surface roughness are desirable. Here, NP assembly provides surface roughness, while low surface energy materials (e.g., flouorosilane on F—SiO₂ and Cytop™) passivate the surface, thus, preventing exposure of the substrate, which may be relatively hydrophilic. CYTOP™ also provides adhesion to enhance the mechanical robustness of the coating on the substrate. The one-pot solution can be spin coated, dip coated and spray coated on various substrates without any substrate surface pre-treatment and post-annealing, and passivation. It is noted that, as shown by the exemplary coated Cytop™ layer, the coated layer is suitably thick enough to partially embed and tie the F—SiO₂ NPs, yet not completely cover the NPs as the nanoroughness is useful to achieve superhydrophobicity. Therefore, the relative concentration between F—SiO₂ NPs and Cytop™ will be the key to the success, in addition to surface chemistry of the NPs and NP surface coverage. Key variables include NP concentration, Cytop™ concentration, and choice of solvent, all of which influence NP coverage and distribution on the substrate.

A series of samples with decreased loading of polymer and increased loading of F—SiO₂ NPs were prepared on glass substrates to study the concentration effect to surface topography and wetting behaviors. The ration between particle concentration and polymer concentration increased from sample 1 to sample 6 as shown in Table 30. The atomic force microscopy (AFM) phase images were collected on Dimension 3000 AFM (Digital Instrument) using silicon cantilever by tapping model to investigate the surface morphology of samples with different formula (FIGS. 19-24).

The AFM phase images indicated that the pure polymer surface was flat. The surface roughness increased when more particles were added to the coating. The surface morphology was determined by the relative amount of particles vs. CYTOP™. The covered particles and exposed particles can be distinguished in AFM phase images because of the different hardness and density between particles and polymer. When the ratio of particle concentration to polymer concentration was low, merely small amount of particles were exposed, as shown in FIG. 8. When the ratio increased, more particles were exposed as shown in FIG. 17 to FIG. 23.

The DI water contact angles (CA) on those samples were measured and summarized in Table 30. The CA increased when small amount of polymer combined with large amount of particles (high particle/polymer ratio). At the same time, surface roughness, indicated by roughness index r measured from AFM images, increased first, then decreased. The difference between advancing contact angle and receding contact angle, so called contact angle hysteresis, showed similar trend as the change of surface roughness.

The theoretical Wenzel CA, θ_{w}, was calculated by Wenzel model, cos θ_{w}=r cos θ₀, using static contact angle on pure polymer film as θ₀ and r from AFM data. The measured static CA and theoretical Wenzel CA were plotted versus the ratio between particle concentration and polymer concentration. The different between measured CA and theoretical Wenzel CA increased with the increase of ration between particle concentration and polymer concentration. The result suggested the conversion from Wenzel wetting state to Cassie wetting state.

The UV-vis spectra were collected on bare glass, glass with polymer coating and glass with polymer/particle coating (sample 5, Table 30) to check the transparency, as given in FIG. 26. The plots showed polymer coating had higher transparency than bare glass. As to polymer/particle coating, the transparency was higher than that of bare glass at long wavelength region and slightly lower at short wavelength region. On average, the polymer coating had overall transparency of 101.14% and the polymer/particle coating had overall transparency of 100.62% in visible region. The UV-vis result indicated the transparency of the coating.

The stability of polymer/particle coating on APTMS treated glass substrates was investigated using Scotch tape test. The Scotch tape was pressed on the coating to ensure good contact and peeled off. The water CA's before and after taping were collected. As seen in FIG. 25, no significant change was observed before and after the peel tests, suggesting that the polymer/particle coating was rather robust compared to nanoparticle coating only.

AFM phase images of the coating before (FIG. 117-23) and after (FIG. 26-32) Scotch tape tests were compared. Sample 1 to sample 5 had similar morphologies, indicating both the polymer coating and polymer/particle coatings were robust. In sample 6, however, after tape test, no particles were observed, but ring-like structure, indicating where the particles used to sit. The result confirmed polymers acted to somewhat enhance coating stability.

The section analysis was further done on the AFM height image of sample 6 (Table 30) after tape test, as shown in FIG. 32. The dimension of ring structures (slightly smaller than 100 nm) matched the size of particles used in the formula, which confirmed those structures were generated after the removal of particles. Thus, AFM analysis indicated that with a range of polymer/particle ratio, the coatings were robust against Scotch tape test.

The formulation optimized from glass substrates was then applied to polymer substrates, such as polycarbonate (PC), which is commonly used in eye protective equipment (e.g. eye glasses, safety glasses). The DI water CA's were measured on bare PC, PC coated with particle/polymer mixture before and after Scotch tape test (see Table 30).

Compared to the CA on the PC, the significantly increased contact angle on coated PC indicated the coating was successfully applied to the PC. In addition, the CA maintained similar value after tape test, suggesting stability of the coating on PC substrate.

AFM phase images of tape tested samples were collected to further investigate the structure and stability of coating on PC substrate. As seen in FIG. 33, similar surface morphology was observed as the coating on a glass substrate. Nanoparticle coverage remained intact after the peeling test, indicating the stability of the coating.

Additional discussion is provided in Karunkaran, Lu, Zhang, and Yang, “Highly Transparent Superhydrophobic Surfaces from the Coassembly of Nanoparticles (<100 nm)”, Langmuir (2011), the entirety of which is incorporated herein by reference.

### Example 1

### Surface Treatment of Silicon Substrates

Si wafers were precleaned using 1% solution (v/v) of Detergent 8 (a low foaming phosphate free cleaner soap solution from Alconox) in deionized (DI) water at 65° C. for 1 h, followed by sonication in DI water, isopropanol and acetone for 20 min, respectively. After drying, the substrates were treated with oxygen plasma (30 W, 0.2 Torr, Harrick plasma cleaner PDC-001) for 1 h. The oxidized Si wafers were then silanized immediately by immersing them in 0.01 M TESPSA in anhydrous toluene overnight. The physisorbed silane was removed by sonicating in ethanol and acetone for 30 min, respectively, followed by drying with compressed air. The fluorosilane treatment on Si wafers was done by vapor deposition of F-silane for 1 h onto oxidized Si wafers in vacuo.

### Example 2

### Surface Functionalization of Silica Nanoparticles

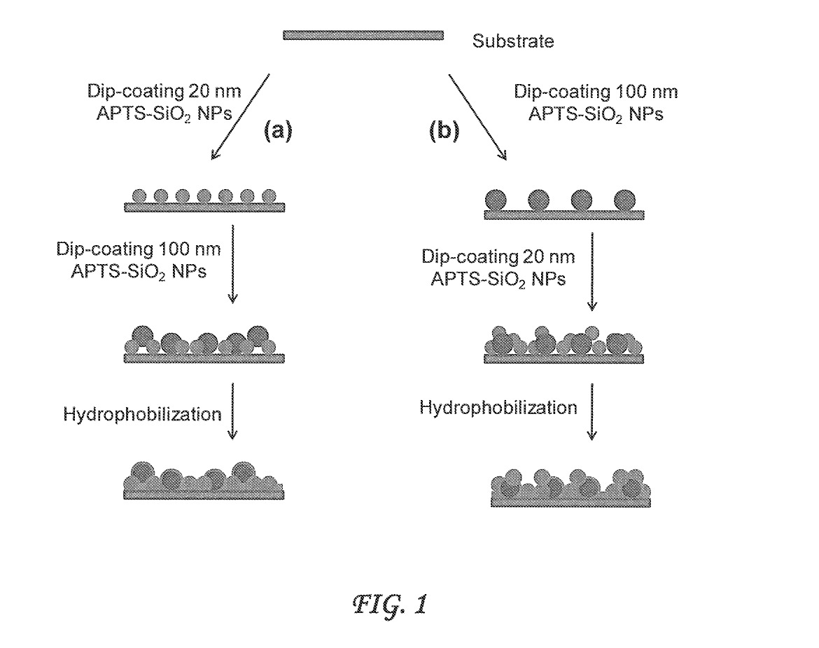

The as-received silica nanoparticles were pelletized by centrifugation at 11 000 rpm overnight, followed by drying under vacuum for 3 h. The nanoparticles were then functionalized with HDFTHD using triethyl amine (TEA) as an acid scavenger. In a typical experiment, 5.0 g silica nanoparticles were dispersed in 50 mL of toluene. 1 mL TEA was added to this NP dispersion under nitrogen atmosphere. Then 5 mL 0.01 M HDFTHD/toluene solution was added to the nanoparticles suspension and allowed to react at room temperature for at least 18 h (FIG. 1). Once the NP surface was functionalized with sufficient amount of HDFTHD, it started to precipitate along with TEA salts. The fluorofunctionalized silica nanoparticles (F—SiO₂ nanoparticles) were purified via centrifugation at 6000 rpm for 3 h, followed by repeated washing with acidified water, water, ethanol, and toluene, respectively, to remove TEA salts and unreacted and partially functionalized silica nanoparticles. Additional centrifugation could be performed if necessary. Finally, the F—SiO₂ nanoparticles were dried under a vacuum for 3 h.

### Example 3

### Functionalized Nanoparticles

As-received silica nanoparticles, NPs, were pelletized by centrifugation at 9,000 rpm (Eppendorf 5804R) for 3 h, followed by drying under vacuum for 3 h (ca. 10 millitorr). The dried NPs were then functionalized with heptadecafluorotetrahydrouoctyldimethychlorosilane (HDFTHD). In a typical experiment, 3.0 g silica NPs were dispersed in 30 mL of anhydrous toluene. The mixture was sonicated (Branson 2210) for 10 min to have well separated particles. Then 0.6 mL triethylamine (Et3N) was added to mixture with rapid stir and kept stirring for another 10 min. 0.9 mL HDFTHD were added to this NP dispersion under nitrogen atmosphere. The dispersion was white when all reaction agents were loaded and well mixed. The reaction was carried out at room temperature for at least 18 h with rapid stir. The color of dispersion changed from white to light brown during the reaction. The fluorosilane-functionalized silica NPs (F—SiO₂ NPs) were precipitated via centrifugation at 1,000 rpm for 5 min. 30 mL ethanol was added to wash and removed by centrifuging at 1,000 for 5 min. 30 mL DI water was added to wash and removed by centrifuging at 1,000 for 10 min. Another 30 mL ethanol was added to wash and removed by centrifuging at 1,000 for 30 min. Additional centrifugation could be performed if necessary. Finally, the F—SiO₂ NPs were dried under vacuum (10 mtorr) for 3 h. The final product was white fine powder.

### Example 4

### Preparation of Nanoparticles/Polymer Coating

Certain amount of CYTOP™ polymer, F—SiO₂ NPs and solvent, Novec 7300 (3M, St. Paul, Minn., USA) were mixed. The mixture was sonicated for 30 min for good dispersion, and then spin coated on aminopropyl trimethoxylsilane (APTMS) treated glass using Cee™ spin coater (Model 100CB) at 500 rpm for 10 s at a acceleration of 100 rpm/s, then 2000 rpm for 30 s at a acceleration of 500 rpm/s.

### Example 4

### Preparation of Mono-Scale Nanoparticle Films

For spin-coating, the F—SiO₂ nanoparticles were dispersed in Novec 7300 at different weight percentages and sonicated fro 30 min prior to use. They were then spin coated at 1500 rpm for 20 s at a velocity of 150 rmp/s onto TESPSA treated Si wafers. For dip-coating of F—SiO₂ nanoparticles, the silanized Si wafers were immersed into a decafluoropentane solution of well-dispersed F—SiO₂ nanoparticles with different concentrations for 10 s and withdrawn at a rate of 4 cm/min.

### Example 5

### Preparation of Dual Scale Nanoparticle Films

The substrate was first functionalized with triethoxysilyl propylsuccinicanhydride silane (95%, Gelest, Inc., Morrisville, Pa. 19067), followed by dip coating of nanoparticles to create dual-scale roughness. Silica nanoparticles (100±3 nm size and 20±3 nm size, 30 Wt % in isopropanol, IPA) as IPA-ST-MS (17-23 nm), IPA-ST-L (40-50 nm) and IPA-ST-ZL (70-100 nm) in 30-31 Wt % IPA from Nissan Chemical America Corporation (Houston, Tex. 77042) were pelletized by centrifugation at 11,000 rpm overnight, followed by drying under vacuum for 3 h. The particles were then amine functionalized via reaction with 3-aminopropyltrimethoxysilane (APTS, 99%, from Sigma-Aldrich, St. Louis, Mo. 63103). A 5% (v/v) APTS ethanol solution was added to the nanoparticle suspension in anhydrous ethanol, and allowed to react at 80° C. for 8 h. The nanoparticles were then purified via centrifugation using the same procedure as above and dried under vacuum for 3 h. After amine-functionalization of the nanoparticles, the substrate was dip coated with a 0.5 wt % ethanol solution of APTS functionalized 20 nm silica nanoparticles. The sample was immersed in ethanol solution for 5 s, followed by withdrawing into the air at a speed of 4 cm min⁻¹. The nanoparticle film was then coated with APTS functionalized 100 nm particles by immersing the substrate in a nanoparticle solution in ethanol 0.8 wt % (0.5 wt % and 1 wt % also) for 5 s, followed by withdrawing into the air at a speed of 4 cm min⁻¹ The nanoparticle assembly was subjected to oxygen plasma treatment (Harrick Expanded Plasma Cleaner & PlasmaFlo, Harrick Plasma, Ithaca, N.Y. 14850) at 30 W for 1 min. The substrate was then placed in a desiccator for vapor deposition of (heptadecafluoro-1,1,2,2,-tetrahydrodecyl)trichlorosilane (99%, Gelest, Inc.), with 100 μl placed on a glass slide.

### Example 6

### Water Drop Test and Scotch Tape Test

In a water drop test, about 1000 water droplets (ca. 80 μL) were dropped from about 1 ft above a sample, and the water contact angle was measured on the sample. In the tape test, pressure was applied to ensure contact between the tape and NP coating, followed by peeling the tape. DI water contact angles and AFM images were collected before/after the tests.

Additional Disclosure

One-step corrosion resistant spray coatings were formulated from three different nanoparticles (NPs) and binders. The NPs were silica NPs (100 nm in diameter, Nissan Chemicals) modified with the fluorosilane, (heptadecafluoro-1,1,2,2-tetrahydrodecyl)dimethylchlorosilane (Gelest), referred as F-NP. Two types of polymer binders were used, including a methyl silicon based glass resin (GR653L, Techneglas Inc.), and a perfluorinated polymer, Cytop®, CTL-109-AE (AGC Chemicals America Inc.). NP and binders were formulated based on a weight by volume percentage (wt/vol %) in isopropyl alcohol (IPA) or the fluorinated solvent, CT-SOLV 100E (AGC Chemicals America Inc.). The GR653L/F-NPs were dispersed in IPA while the Cytop®/F-NPs were dispersed in the fluorinated solvent CT-SOLV 100E.

Two formulations consisting of GR653L and F-NPs were made and sprayed on separate printed circuit boards (PCB, Datak) for testing in the salt water solution. 8 or 12 mg/mL GR653L were mixed with 10 mg/mL F-NPs in IPA. Following the mixing, solutions were sonicated for approximately 15 minutes prior to spraying. The Cytop®/F-NP formulation was made by mixing 1 mg/mL Cytop® and 10 mg/mL F-NP in CT-SOLV 100E. The solution was then sonicated for 15 minutes prior to spraying.

The coating formulations were sprayed on PCBs utilizing an airbrush (Master Airbrush, Model G23) attached to a nitrogen gas tank. The pressure utilized for spraying was set at 20 psi for all coating applications. The coating was applied a total of 15 cycles for each solution and PCB. The PCBs were coated as such in order to cover all surface features of the board due to the raised structures of the copper leads. After 3 sprays perpendicular to the PCB, the boards were tilted at approximately 60-degree angles towards the sprayer and away from the sprayer, and coated one time at both angles, respectively. This process was repeated 3 times for each PCB.

The coating thickness for each formulation was characterized by atomic force microscopy (AFM). Samples were sprayed on silicon wafers in the same manner as the PCB boards. The coatings were scratched using a sharp needle and scanned by AFM in the contact mode in order to image the thickness profile of the coating. Coating thicknesses for the GR653L/F-NP were found to be 600-800 nm while the Cytop®/F-NPs coating was found to be roughly 100-200 nm.

Coatings were sprayed on glass slides (15 times) for Water contact angle (WCA) measurement. The results of the WCA measurements are summarized in the table below.

| | Sample | | |
|---|---|---|---|
| | 8 mg/mL | 12 mg/mL | 1 mg/mL |
| | GR653 + 10 | GR653 + 10 | Cytop ® + 10 |
| | mg/mL F-NP | mg/mL F-NP | mg/mL F-NP |
| WCA | 129.7 ± 3.8 | 100.0 ± 4.6 | 154.9 ± 2.8 |
| (degrees) | | | |

To test the corrosion resistant properties of the as-described coating solutions, an experimental set-up as shown in FIG. 34 was utilized. A direct current (DC) of 20 V was run down 1 of the copper leads as displayed in FIG. 34. The coated PCB was then submersed in a salt water environment (85 g Mortons Salt in 0.5 L deionized water). Without being bound to any particular theory, in an electrolytic environment, there would be the presence of current due to the electrical conductivity of salt water, and the copper leads would be destroyed within seconds due to corrosion. However, if the coating provides anti-corrosion properties, the ions in the salt water will not be able to penetrate the coating and corrode the copper substrate. Therefore, there should not be any current generated between the copper leads, until the ions could freely interact with the copper substrate and provide a path for the electrons to travel in a closed circuit. The current was measured as a function of time using the LabView program. FIGS. 35-37 show results for the thickness of the coating as measured by AFM, and the anti-corrosion properties of the films. As seen in FIG. 35C and 36C, the PCBs were functional up to 8 h (the max measurement time). Very small noises in current (<0.003 A and <0.001 A) could be observed at ˜2 h and ˜4 h testing for the 8 mg/mL and 12 mg/mL GR653L formulations, respectively, likely due to system error or defects. The Cytop formulation (FIG. 37C) has no measurable current up to 8 h.

One-step coatings were also formulated for the use on textiles. In this case, woven cotton, and nylon mesh were coated. Without superhydrophobic coatings, cotton is highly absorbent, while the mesh feature of nylon would allow water drops to fall directly through. Two different coating formulations were utilized, mainly, the type of silica particle. For both formulations fumed GR653L was added as a polymer binder material. Hydrophobic silica NPs (Aerosil® series, Evonik Industries) were utilized for one formulation in combination with GR653L, while 40-50 nm diameter silica particles (Nissan Chemical) co-modified with HDDMCS and 3-glycioxypropyltrimethoxysilane (GPTMS) were also employed. Both formulations were combined in wt/vol %. 10 mg/mL of NP and 8 mg/mL GR653L. Mixed solutions were sonicated for 15 minutes prior to spraying. The textiles were sprayed a total of 5 times with the spray system as described above. Both formulations gave similar results. A typical coated swatch of nylon and cotton is seen in FIG. 38.

As shown in FIG. 38, the spray coatings form superhydrophobic textile surfaces that repel water from both hydrophilic textiles (Cotton), and open mesh frame textiles such as nylon pictured here. The water contact angle for both films was above 150°. Also, droplets easily rolled off the coated substrate. Most importantly, as you can see in FIG. 38, the water did not penetrate the highly water adsorbing cotton textile, and also, the water droplet did not fall through the mesh membrane and wet the white paper underneath. In conclusion, both textiles exhibited high superhydrophobic wetting behavior from a single step spray coating solution.

When ranges are used herein for physical properties or chemical properties (e.g., chemical formulae), all combinations and subcombinations of ranges for specific embodiments therein are intended to be included. The disclosures of every document cited or described herein are hereby incorporated herein by reference, in its entirety. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A hydrophobic article, comprising,
a substrate at least partially surmounted by a first population of nanoparticles, the first population of nanoparticles contacting a second population of nanoparticles,
the first and second populations of nanoparticles differing from one another in cross-sectional dimension, and
a low surface energy material surmounting at least some of the first and second populations of nanoparticles so as to form a hydrophobic layer comprising the first and second populations of nanoparticles and the low surface energy material, the hydrophobic layer being exposed to the environment exterior to the article.

2. The hydrophobic article of claim 1, wherein the hydrophobic layer is characterized as being essentially transparent.

3. (canceled)

4. The hydrophobic article of claim 1, wherein one or more nanoparticles comprise (heptadecafluoro-1,1,2,2-tetrahydrodrodecyl) dimethylchlorosilane (HDFTHD), tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, and n-octadecyldimethylchlorosilane, or dodecyldimethylchlorosilane, or any combination thereof.

5. The hydrophobic article of claim 1, wherein the substrate comprises silicon, glass, poly(dimethylsiloxane), polyester, polystyrene, poly(methyl methacrylate), poly(carbonate), a plastic film, a fabric, or any combination thereof.

6. (canceled)

7. (canceled)

8. The hydrophobic article of claim 1, wherein at least some of the first population of nanoparticles, at least some of the second population of nanoparticles, or both, comprise an amine, a carboxylic acid, a hydroxyl, a glycidol group, or any combination thereof.

9. (canceled)

10. The article of claim 1, wherein the average cross sectional dimension of at least one of the first or second populations of nanoparticles is in the range of from about 10 nm to about 200 nm.

11. The article of claim 1, wherein the ratio between the average cross-sectional dimension of the first and second populations of nanoparticles is between about 0.0001 to about less than 1.

12. The hydrophobic article of claim 1, wherein the low surface energy material comprises a hydrophobic alkyl chain silane.

13. The hydrophobic article of claim 1, wherein the low surface energy material comprises (heptadecafluoro-1,1,2,2-tetrahydrodecyl(trichlorosiloxane), heptadecafuloro-1,1,2,2-tetrahydrodecyl(dimethylchlorosiloxane), fluoroalkyl monosilane, perfluoroether di-silane, perfluoroether poly-silane, n-octadecyltrichlorosilane, dimethyloctadecylchlorosilane, decyltrichlorosilane, or any combination thereof.

14. A method of fabricating a hydrophobic article, comprising:
contacting a substrate with a first population of nanoparticles so as to bind at least a portion of the first population of nanoparticles to the substrate,
at least one of the substrate and the first population of nanoparticles being configured to bind to the other;
introducing a second population of nanoparticles so as to give rise to the second population of nanoparticles binding to the substrate, to the first population of nanoparticles, or both, so as to give rise to a particle-bearing article; and
depositing a low surface energy material atop at least a portion of the particle-bearing article.

15. The method of claim 14, wherein one or more nanoparticles comprises (heptadecafluoro-1,1,2,2-tetrahydrodrodecyl) dimethylchlorosilane, tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, and n-octadecyldimethylchlorosilane, or dodecyldimethylchlorosilane.

16. (canceled)

17. (canceled)

18. (canceled)

19. (canceled)

20. The method of claim 14, wherein the substrate comprises silicon, glass, poly(dimethylsiloxane), polyester, poly(styrene), poly(methyl methacrylate), poly(carbonate), a plastic film, a fabric, or any combination thereof.

21. (canceled)

22. The method of claim 14, wherein the first and second populations of nanoparticles differ from one another in at least cross-sectional dimension.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A hydrophobic article, comprising:
a substrate;
the substrate being at least partially surmounted by a coating, the coating including a population of surface functionalized nanoparticles,
at least some of the nanoparticles of the coating comprising fluorosilanate surface functionalities.

58. The hydrophobic article of claim 57, wherein the coating is essentially transparent.

59. The hydrophobic article of claim 57, wherein the substrate is treated with (heptadecafluoro-1,1,2,2-tetrahydrodecyl)trichlorosilane, dimethylchlorosilane with hydrophobic end groups, such as (heptadecafluoro-1,1,2,2-tetrahydrodrodecyl) dimethylchlorosilane, tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, n-octadecyldimethylchlorosilane, dodecyldimethylchlorosilane or any combination thereof.

60. The hydrophobic article of claim 59, wherein the substrate comprises 3 (triethoxysilyl)-propyl succinic anhydride (TESPSA), trimethoxysilylproprylsuccinic anhydride, aminopropyltriethoxysilane, aminopropyltrimethoxysilane, 3-glycidopropyltriethoxysilane, 3-glycidopropyltrimethoxysilane, aminobutyldimethylmethoxysilane, or any combination thereof.

61. The hydrophobic article of claim 57, wherein at least some of the nanoparticles are functionalized with dimethylchlorosilane with hydrophobic end groups, such as (heptadecafluoro-1,1,2,2-tetrahydrodrodecyl) dimethylchlorosilane, tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, n-octadecyldimethylchlorosilane, dodecyldimethylchlorosilane or any combination thereof.

62. (canceled)

63. A method of fabricating a hydrophobic article, comprising:
dispersing a population of surface functionalized hydrophobic nanoparticles and a low energy polymer to give rise to an admixture; and
depositing the admixture onto a substrate.

64. (canceled)

65. (canceled)

66. (canceled)

67. The method of claim 63, wherein at least one nanoparticles comprises a chlorosilane with a hydrophobic end group.

68. The method of claim 63, wherein the low surface energy polymer comprises a fluorinated polymer, a semifluorinated polymer, a perfluoropolyether, or any combination thereof.

69. The method of claim 63, wherein the substrate comprises one or more chemical groups capable of bonding with the low surface energy polymer.

70. The method of claim 63, wherein the substrate is treated with 3-(triethoxysilyl)-propyl succinic anhydride, trimethoxysilylproprylsuccinic anhydride, aminopropyltriethoxysilane, aminopropyltrimethoxysilane, 3-glycidopropyltriethoxysilane, 3-glycidopropyltrimethoxysilane, aminobutyldimethylmethoxysilane, or any combination thereof.

71. (canceled)

72. A hydrophobic article, comprising:
a substrate; and a coating surmounting the substrate, the coating comprising a population of surface functionalized nanoparticles and a low surface energy polymer.

73. The hydrophobic article of claim 72, wherein the coating is essentially transparent.

74. (canceled)

75. The hydrophobic article of claim 72, wherein the surface of the nanoparticles are functionalized with Dimethylchlorosilane with hydrophobic end groups, such as (heptadecafluoro-1,1,2,2-tetrahydrodrodecyl) dimethylchlorosilane, tridecafluoro-1,1,2,2-tetrahydroctyldimethylchlorosilane, 2-(di-n-octylmethylsilyl)ethyldimethylchlorosilanne, nonafluorohexyldimethylchlorosilane (3,3,3-trifuloropropyl)dimethylchlorosilane, n-octadecyldimethylchlorosilane, dodecyldimethylchlorosilane or any combination thereof.

76. The hydrophobic article of claim 72, wherein the low surface energy polymer comprises a fluorinated polymer, a semifluorinated polymer, a perfluoropolyether, or any combination thereof.

77. (canceled)
